(19) United States
(12) Patent Application Publication
(10) Pub. No.: US 2013/0335684 A1
(43) Pub. Date: Dec. 19, 2013

(54) BONDING PANEL, DISPLAY UNIT, AND DISPLAY DEVICE

(71) Applicants: Kazuhiro Yoshikawa, Osaka-shi (JP); Kazunori Tanimoto, Osaka-shi (JP); Masayuki Tsuji, Osaka-shi (JP); Takayuki Hayano, Osaka-shi (JP); Nobuhiro Nakata, Osaka-shi (JP); Yoshihiro Asai, Osaka-shi (JP); Masahiro Yoshida, Osaka-shi (JP); Tatsuji Saitoh, Osaka-shi (JP); Isao Ogasawara, Osaka-shi (JP)

(72) Inventors: Kazuhiro Yoshikawa, Osaka-shi (JP); Kazunori Tanimoto, Osaka-shi (JP); Masayuki Tsuji, Osaka-shi (JP); Takayuki Hayano, Osaka-shi (JP); Nobuhiro Nakata, Osaka-shi (JP); Yoshihiro Asai, Osaka-shi (JP); Masahiro Yoshida, Osaka-shi (JP); Tatsuji Saitoh, Osaka-shi (JP); Isao Ogasawara, Osaka-shi (JP)

(21) Appl. No.: 13/981,532

(22) PCT Filed: Jan. 18, 2012
(86) PCT No.: PCT/JP2012/050988

§ 371 Date: Aug. 21, 2013

(30) Foreign Application Priority Data
Jan. 25, 2011 (JP) 2011-013037

(51) Int. Cl. G02F 1/1333

(52) U.S. Cl. CPC G02F 1/1333
USPC 349/96; 349/122; 428/77

(57) ABSTRACT

A functional panel (FP) includes a COM substrate (4) and an SEG substrate (3) that face each other. The functional panel (FP) is combined with a display panel (LP) via an adhesive. The COM substrate (4), which is provided farther from the display panel (LP) than the SEG substrate (3) is, has edges (E1, E2) that face each other. The SEG substrate (3), which is provided closer to the display panel (LP) than the COM substrate (4) is, has (i) an edge (E3) provided along and inside the edge (E1) when viewed from above and (ii) an edge (E4) provided along and inside the edge (E2) when viewed from above. This effectively prevents the occurrence of a defective external shape.

### TECHNICAL FIELD

The present invention relates to (i) a bonding panel to be combined with a target panel via an adhesive, (ii) a display unit, and (iii) a display device.

### BACKGROUND ART

In recent years, development has been fostered of a display device that not only functions as an image display device for merely displaying a flat image but also achieves various functions by including a functional panel on a front surface of a display panel of the display device.

For example, the display device is capable of, by including a functional panel having a parallax barrier function on the front surface, (i) switching between 2D (flat) image display and 3D (stereoscopic) image display and (ii) dual-view display which is to display, with a single display screen, different images depending on which direction an observer views the images from.

In general, such a functional panel is combined with a front surface of a display panel via an adhesive. This is how a display device having a functional panel is configured.

However, the use of an adhesive to combine together a functional panel and a display panel causes, in some cases, the adhesive to be pressed out from a space between the display panel and the functional panel. If a large amount of the adhesive is pressed out, then it causes an external shape of the display panel combined with the functional panel to be large, and therefore results in cracks and incorrect positioning when the display panel combined with the functional panel is to be mounted on a module or on a manufactured product.

Hence, it is necessary to trim off pressed-out parts of the adhesive in order to correct the external shape of the display panel. This causes an increase in production costs.

Patent Literature 1 discloses a display device capable of dual view display by combining, via an adhesive, a parallax barrier substrate with a liquid crystal display panel.

FIG. 20 is a cross-sectional view illustrating a configuration of a display device disclosed in Patent Literature 1. As illustrated in FIG. 20, a liquid crystal display device 500 includes (i) a liquid crystal display panel 510 for displaying an image and (ii) a parallax barrier substrate 520 provided, via an adhesive resin layer 518, on a front side of the liquid crystal display panel 510.

The parallax barrier substrate 520 includes (i) a glass substrate 521 and (ii) a transmission controlling section 522 for controlling images that can be viewed, depending on which of directions Z1 and Z2 an observer views the images from. The transmission controlling section 522 is made up of (a) a plurality of transmissive slits provided so as to linearly extend in parallel and (b) light shielding parts provided in spaces between the plurality of transmissive slits.

The parallax barrier substrate 520 is provided with a cut-out part 520a that is made by partially cutting out, in a thickness direction, a liquid-crystal-display-panel-510 side of a periphery of the parallax barrier substrate 520, which periphery is arranged so as to be aligned with a periphery of the liquid crystal display panel 510. Part of the cut-out part 520a is defined by an inclined side surface of the parallax barrier substrate 520, and is provided along the entire periphery of the parallax barrier substrate 520. The cut-out part 520a is formed by (i) chamfering the glass substrate 521 by grinding the glass substrate 521, (ii) etching the glass substrate 521, or the like.

The liquid crystal display device 500 thus includes the cut-out part 520a on the periphery of the parallax barrier substrate 520. This causes, when the liquid crystal display panel 510 is combined with the parallax barrier substrate 520, an adhesive resin material to be pushed into the cut-out part 520a, which adhesive resin material (i) has been pressed out of a space between the liquid crystal display panel 510 and the parallax barrier substrate 520 and (ii) is to be the adhesive resin layer 518. Hence, it is possible to prevent the adhesive resin layer 518, which is formed by curing the adhesive resin material, from sticking out from the space between the liquid crystal display panel 510 and the parallax barrier substrate 520.

### CITATION LIST

### Patent Literatures

Patent Literature 1
Japanese Patent Application Publication, Tokukai, No. 2009-192660 A (Publication Date: Aug. 27, 2009)

Patent Literature 2
Japanese Patent Application Publication, No. WO2008/047785 (International Publication Date: Apr. 24, 2008)

### SUMMARY OF INVENTION

### Technical Problem

However, since the parallax barrier substrate 520 is made up of a single glass substrate 521 and a single transmission controlling section 522, the parallax barrier substrate 520 is relatively thin. Even if the cut-out part 520a is provided on the relatively thin parallax barrier substrate 520, there is not much increase in a volume of a space between the cut-out part 520a and the liquid crystal display panel 510.

Hence, the configuration of the liquid crystal display device 500 does not sufficiently bring about an effect of reducing the amount of the adhesive resin layer 518 sticking out of the space between the liquid crystal display panel 510 and the parallax barrier substrate 520 combined together.

The present invention has been made in view of the problem, and it is an object of the present invention to effectively prevent a defective external shape of a display panel combined with a functional panel.

### Solution to Problem

In order to attain the object, a bonding panel of the present invention, which is to be combined with a target panel via an adhesive, includes a first substrate and a second substrate provided so as to face each other, the first substrate being provided farther from the target panel than the second substrate is, the first substrate having a first edge and a second edge which face each other, and the second substrate having, when viewed from above, (i) a third edge provided along and inside the first edge and (ii) a fourth edge provided along and inside the second edge.

According to the configuration, a step is formed by the first and second edges, and another step is formed by the second and fourth edges. This allows, when the bonding panel is combined with the target panel via the adhesive, pressed-out parts of the adhesive to flow into the steps formed by the first and second edges and into the steps formed by the third and fourth edges. Therefore, a defective external shape can be more effectively prevented.

### Advantageous Effects of Invention

A bonding panel of the present invention, which is to be combined with a target panel via an adhesive, includes a first substrate and a second substrate provided so as to face each other, the first substrate being provided farther from the target panel than the second substrate is, the first substrate having a first edge and a second edge which face each other, and the second substrate having, when viewed from above, (i) a third edge provided along and inside the first edge and (ii) a fourth edge provided along and inside the second edge.

Hence, it is possible to effectively prevent the defective external shape.

### BRIEF DESCRIPTION OF DRAWINGS

(a) of FIG. 1 is a plan view illustrating a configuration of a display unit in accordance with Embodiment 1.

(b) of FIG. 1 is a cross-sectional view taken along the line A-A′ illustrated in (a) of FIG. 1.

(c) of FIG. 1 is a cross-sectional view taken along the line B-B′ illustrated in (a) of FIG. 1.

FIG. 2 is a block diagram illustrating a configuration of a display device of the present invention.

(a) of FIG. 3 is a plan view illustrating a configuration of a functional panel in accordance with Embodiment 1.

(b) of FIG. 3 is a cross-sectional view taken along the line C-C′ illustrated in (a) of FIG. 3.

(c) of FIG. 3 is a cross-sectional view taken along the line D-D′ illustrated in (a) of FIG. 3.

FIG. 4 is a plan view illustrating a configuration of an SEG electrode provided on an SEG substrate of Embodiment 1.

FIG. 5 is a plan view illustrating a configuration of a COM electrode provided on a COM substrate of Embodiment 1.

FIG. 6 is an enlarged view of a region X illustrated in FIG. 3.

(a) of FIG. 7 is a plan view illustrating a configuration of another display unit in accordance with Embodiment 1.

(b) of FIG. 7 is a cross-sectional view taken along the line A-A′ illustrated in (a) of FIG. 7.

(c) of FIG. 7 is a cross-sectional view taken along the line B-B′ illustrated in (a) of FIG. 7.

(a) of FIG. 8 is a plan view illustrating a configuration of a display unit in accordance with Modification 1 of Embodiment 1.

(b) of FIG. 8 is a cross-sectional view taken along the line E-E′ illustrated in (a) of FIG. 8.

(c) of FIG. 8 is a cross-sectional view taken along the line F-F′ illustrated in (a) of FIG. 8.

(a) of FIG. 9 is a plan view illustrating another configuration of the display unit in accordance with Modification 1 of Embodiment 1.

(b) of FIG. 9 is a cross-sectional view taken along the line E-E′ illustrated in (a) of FIG. 9.

(c) of FIG. 9 is a cross-sectional view taken along the line F-F′ illustrated in (a) of FIG. 9.

(a) of FIG. 10 is a plan view illustrating a configuration of a display unit in accordance with Modification 2 of Embodiment 1.

(b) of FIG. 10 is a cross-sectional view taken along the line G-G′ illustrated in (a) of FIG. 10.

(c) of FIG. 10 is a cross-sectional view taken along the line H-H′ illustrated in (a) of FIG. 10.

(a) of FIG. 11 is a plan view illustrating another configuration of the display unit in accordance with Modification 2 of Embodiment 1.

(b) of FIG. 11 is a cross-sectional view taken along the line G-G′ illustrated in (a) of FIG. 11.

(c) of FIG. 11 is a cross-sectional view taken along the line H-H′ illustrated in (a) of FIG. 11.

(a) of FIG. 12 is a plan view illustrating a configuration of a display unit in accordance with Modification 3 of Embodiment 1.

(b) of FIG. 12 is a cross-sectional view taken along the line I-I′ illustrated in (a) of FIG. 12.

(c) of FIG. 12 is a cross-sectional view taken along the line J-J′ illustrated in (a) of FIG. 12.

(a) of FIG. 13 is a plan view illustrating another configuration of the display unit in accordance with Modification 3 of Embodiment 1.

(b) of FIG. 13 is a cross-sectional view taken along the line I-I′ illustrated in (a) of FIG. 13.

(c) of FIG. 13 is a cross-sectional view taken along the line J-J′ illustrated in (a) of FIG. 13.

(a) of FIG. 14 is a plan view illustrating a configuration of a display unit in accordance with Embodiment 2.

(b) of FIG. 14 is a cross-sectional view taken along the line K-K′ illustrated in (a) of FIG. 14.

(c) of FIG. 14 is a cross-sectional view taken along the line L-L′ illustrated in (a) of FIG. 14.

(a) of FIG. 15 is a plan view illustrating another configuration of the display unit in accordance with Embodiment 2.

(b) of FIG. 15 is a cross-sectional view taken along the line K-K′ illustrated in (a) of FIG. 15. (c) of FIG. 15 is a cross-sectional view taken along the line L-L′ illustrated in (a) of FIG. 15.

(a) of FIG. 16 is a plan view illustrating a configuration of a display unit in accordance with Embodiment 3.

(b) of FIG. 16 is a cross-sectional view taken along the line M-M′ illustrated in (a) of FIG. 16.

(c) of FIG. 16 is a cross-sectional view taken along the line N-N′ illustrated in (a) of FIG. 16.

(a) of FIG. 17 is a plan view illustrating another configuration of the display unit in accordance with Embodiment 3.

(b) of FIG. 17 is a cross-sectional view taken along the line M-M′ illustrated in (a) of FIG. 17.

(c) of FIG. 17 is a cross-sectional view taken along the line N-N′ illustrated in (a) of FIG. 17.

(a) of FIG. 18 is a plan view illustrating a configuration of a display unit in accordance with Modification 1 of Embodiment 3.

(b) of FIG. 18 is a cross-sectional view taken along the line O-O′ illustrated in (a) of FIG. 18.

(c) of FIG. 18 is a cross-sectional view taken along the line P-P′ illustrated in (a) of FIG. 18.

(a) of FIG. 19 is a plan view illustrating another configuration of the display unit in accordance with Modification 1 of Embodiment 3.

(b) of FIG. 19 is a cross-sectional view taken along the line O-O′ illustrated in (a) of FIG. 19.

(c) of FIG. 19 is a cross-sectional view taken along the line P-P′ illustrated in (a) of FIG. 19.

FIG. 20 is a cross-sectional view illustrating a configuration of a conventional display device.

### DESCRIPTION OF EMBODIMENTS

### Embodiment 1

The following description will discuss Embodiment 1 of the present invention.

(Configuration of Display Device 100)

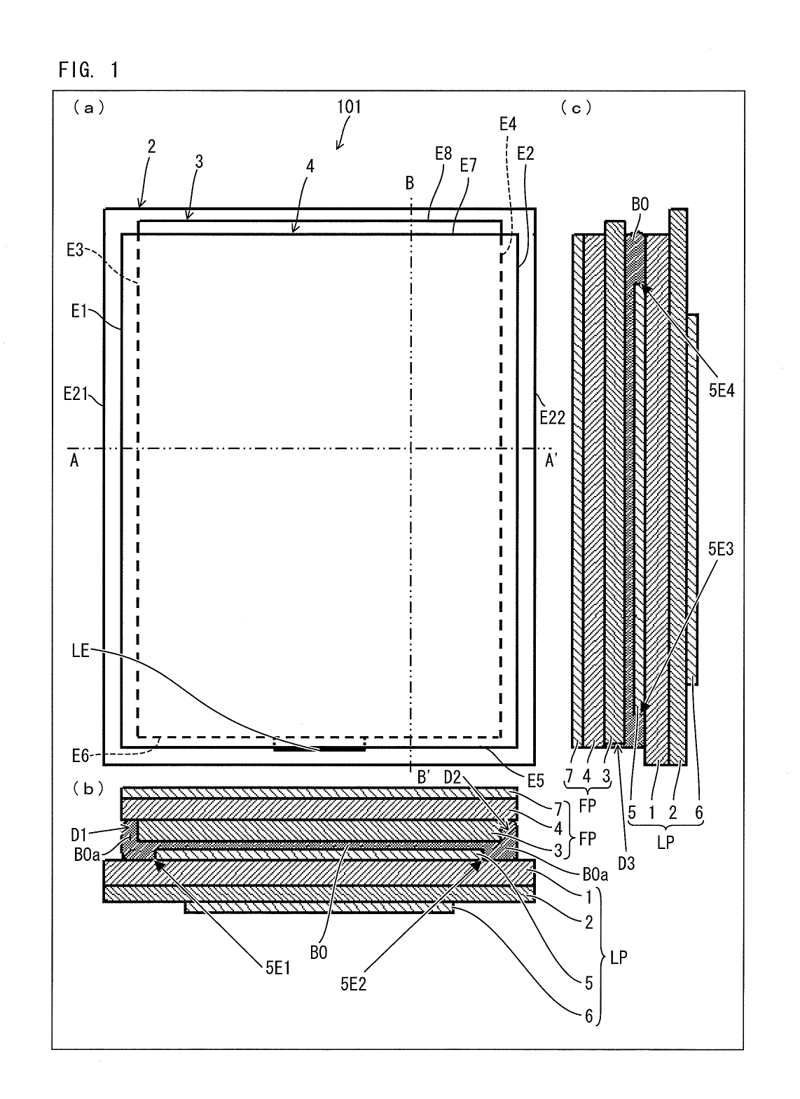

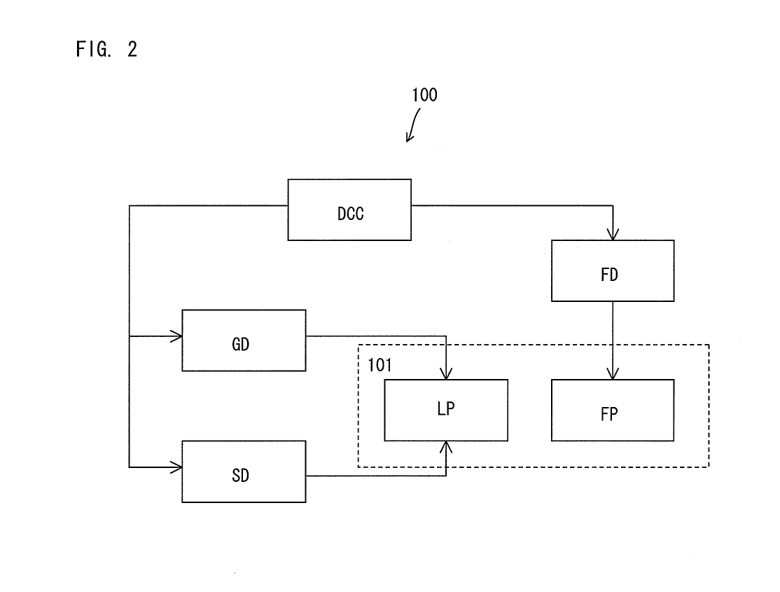

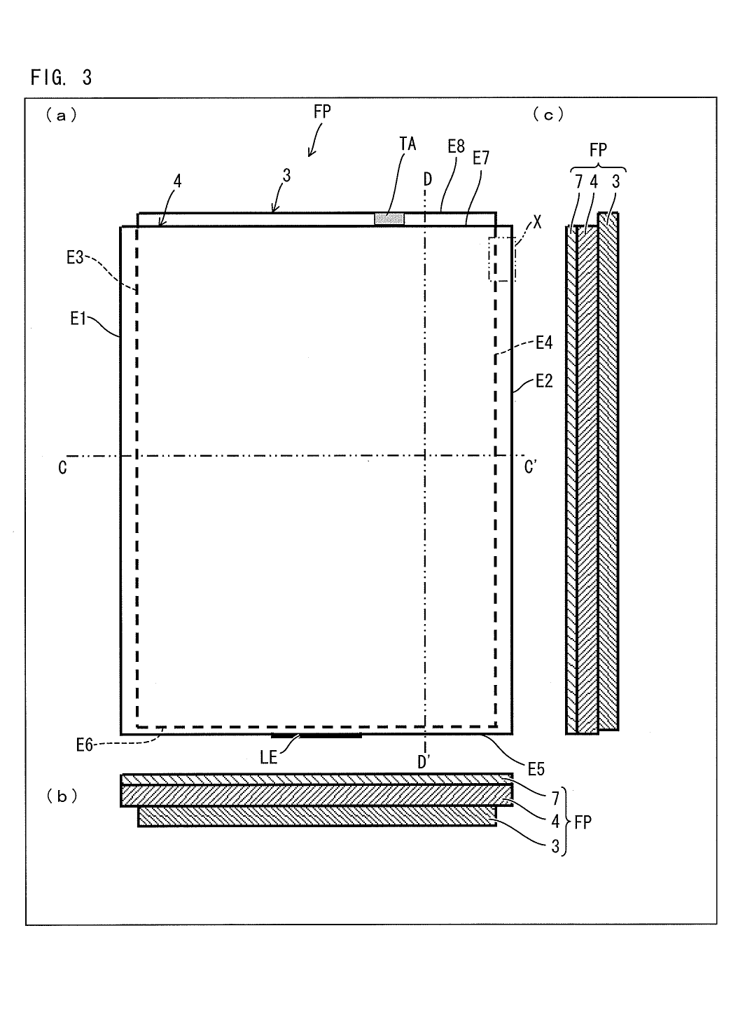

A configuration of a display device 100 in accordance with Embodiment 1 will be first described with reference to FIG. 2.

FIG. 2 is a block diagram illustrating the configuration of the display device 100.

The display device 100 includes a display unit 101, a source driver SD, a gate driver GD, a functional-panel-specific driver FD, and a display control circuit DCC. The display unit 101 includes a display panel LP and a functional panel FP.

The display unit 101 of Embodiment 1 is capable of switching between 2D (flat image) display and 3D (stereoscopic image) display.

The display panel LP is a display panel for displaying an image, and is, for example, a liquid crystal panel. The functional panel FP allows the display panel LP to have an additional function by being combined with the display panel LP via an adhesive.

The functional panel FP of Embodiment 1 is a switching panel causing parallax barriers. The display unit 101 can enable or disable a 3D (stereoscopic) display mode, by combining the functional panel FP with the display panel LP via the adhesive.

The 3D display mode is a mode in which it is possible for an observer (viewer) to view a 3D image by causing a right-eye image and a left-eye image, displayed on the display panel LP, to have respective certain viewing angles so that right and left eyes of the observer view the right-eye image and the left-eye image, respectively.

The functional panel FP is a panel capable of forming a barrier (parallax barrier) with slits so as to control the viewing angles.

Note that specific configurations of the display panel LP and the functional panel FP will be described later.

The display control circuit DCC is provided for controlling overall driving of the display device 100. The display control circuit DCC particularly generates (i) an image display signal that causes the display panel LP to display an image and (ii) a signal for controlling the driving of the functional panel FP.

The display control circuit DCC generates, as the image display signals, source signals and gate signals. The display control circuit DCC supplies (i) the source signals to the source driver SD and (ii) the gate signals to the gate driver GD. Then, (i) the source driver SD supplies the source signals to respective source lines provided on an active substrate of the display panel LP and (ii) the gate driver GD supplies the gate signals to respective gate lines provided on the active substrate of the display panel LP. This causes an image display section of the display panel LP to display an image.

The display control circuit DCC also generates the signal for controlling the driving of the functional panel FP, and then supplies the signal to the functional-panel-specific driver FD. The functional-panel-specific driver FD controls the driving of the functional panel FP by supplying the signal to the functional panel FP. Note that the signal for controlling the driving of the functional panel FP is a signal that is synchronized with an image, which is displayed on the display panel LP in a case where the display unit 101 displays a 3D image.

Note that examples of the source driver SD, the gate driver GD, the functional-panel-specific driver FD, and the display control circuit DCC encompass those employed in a typical display device capable of switching between a 2D image and a 3D image.

Note also that the source driver SD and the gate driver GD can be provided directly on the display panel LP. Alternatively, the source driver SD and the gate driver GD can be provided on a printed circuit board (not illustrated) connected to the display panel LP.

Note that the display device 100 can further include a backlight (not illustrated).

(Display Unit 101)

A configuration of the display unit 101 will be described below with reference to (a) through (c) of FIG. 1.

(a) of FIG. 1 is a plan view illustrating the configuration of the display unit 101 in accordance with Embodiment 1. (b) of FIG. 1 is a cross-sectional view taken along the line A-A′ illustrated in (a) of FIG. 1. (c) of FIG. 1 is a cross-sectional view taken along the line B-B′ illustrated in (a) of FIG. 1.

The display unit 101 includes (i) an adhesive BO, (ii) the functional panel FP, and (iii) the display panel LP for displaying an image. The functional panel FP and the display panel LP are combined with each other via the adhesive BO. The functional panel FP is provided closer to an observer than the display panel LP is.

The adhesive BO, which is in a liquid form, is used to fix the functional panel FP and the display panel LP to each other by the following process: (i) the adhesive BO is applied to one of the functional panel FP and the display panel LP so as to combine them together and then (ii) the adhesive BO is cured with the use of heat or light. Examples of a material for the adhesive BO encompass a typical acrylic material of a thermosetting or photocurable type.

A part of the adhesive BO has a thickness of, for example, approximately 0.05 mmt, which part is interposed between the functional panel FP and a polarizing plate 5 that is provided on a front surface of the display panel LP.

The display panel LP includes an active substrate 2, a counter substrate 1, and polarizing plates 5 and 6. The display panel LP is configured so that the active substrate 2 and the counter substrate 1 face each other via a liquid crystal (not illustrated).

The active substrate 2 is a glass substrate on which (i) a plurality of source lines are provided and (ii) a plurality of gate lines intersecting with the plurality of source lines are provided. According to the active substrate 2, TFT elements for driving the liquid crystal are provided in respective regions into which the active substrate 2 is partitioned by the plurality of source lines and the plurality of gate lines. In the regions, pixel electrodes are connected to the respective TFT elements. The active substrate 2 has a thickness of, for example, approximately 0.2 mmt.

The counter substrate 1 includes a glass substrate, color filters, and a common electrode opposing the pixel electrode. The color filters, which are provided on a back surface (a surface facing the active substrate 2) of the glass substrate, are made up of filters that transmit light of red color, green color, and blue color, for example. The counter substrate 1 is configured so that filters that transmit light of red color, green color, or blue color are provided in regions facing the respective regions into which the active substrate 2 is partitioned by a plurality of signal lines and the plurality of gate lines.

Note that filters that transmit light of yellow color can be further provided, in addition to the three types of filters described above. Alternatively, in a case where a monochrome display device is used, a configuration can be employed in which no color filter is provided. Note that the counter substrate 1 has a thickness of, for example, approximately 0.3 mmt.

The polarizing plate 5 is provided on a front surface of the display panel LP (i.e., a front surface of the counter substrate 1, or a counter surface facing the functional panel FP). The polarizing plate 6 is provided on a back surface of the display panel LP (i.e., a back surface of the active substrate 2). Examples of a material for the polarizing plates 5 and 6 encompass a material, such as polyimide, which is similar to that used as a polarizing plate of a typical liquid crystal panel. Note that the polarizing plates 5 and 6 each have a thickness of, for example, approximately 0.13 mmt.

The functional panel FP is provided on an image-display-section side of the display panel LP, via the adhesive BO.

(Configuration of Functional Panel)

The configuration of the functional panel FP will be described below with reference to (a) through (c) of FIG. 1 and (a) through (c) of FIG. 3.

(a) of FIG. 3 is a plan view illustrating the configuration of the functional panel FP. (b) of FIG. 3 is a cross-sectional view taken along the line C-C′ illustrated in (a) of FIG. 3. (c) of FIG. 3 is a cross-sectional view taken along the line D-D′ illustrated in (a) of FIG. 3.

The functional panel FP is combined with the display panel (target panel) LP via an adhesive BO. The functional panel FP is provided on a viewing side of the display unit 101.

The functional panel (bonding panel) FP includes (i) an SEG substrate (second substrate) 3, (ii) a COM substrate (first substrate) 4, and (iii) a polarizing plate 7, the SEG substrate 3 and the COM substrate 4 facing each other. The functional panel FP further includes a liquid crystal (not illustrated) and alignment films (not illustrated).

The COM substrate 4 is provided farther from the display panel LP than the SEG substrate 3 is. The SEG substrate 3 is provided closer to the display panel LP than the COM substrate 4 is.

The liquid crystal is provided so as to be sandwiched between the SEG substrate 3 and the COM substrate 4. The alignment films, which have each been subjected to rubbing, are provided on respective counter surfaces of the SEG substrate 3 and the COM substrate 4 between which the liquid crystal is sandwiched.

Spacer members are also provided between the SEG substrate 3 and the COM substrate 4 so that a cell gap of the functional panel FP (a gap between the SEG substrate 3 and the COM substrate 4) can be maintained. Examples of the spacer members encompass plastic beads (PB) and columnar spacer members. According to the functional panel FP, (i) fixable black PBs are employed as the spacer members and (ii) a cell gap of approximately 6.5 μm is maintained.

The SEG substrate 3 and the COM substrate 4 each have a thickness of, for example, approximately 0.25 mmt.

The SEG substrate 3 has edges (side surfaces) E3, E4, E6, and E8 that are left, right, top, and bottom sides of the sheet, respectively (see (a) of FIG. 1 and (a) of FIG. 3). The edge E3 (third edge) and the edge E4 (fourth edge) face each other. The edge E6 (sixth edge) and the edge E8 (eighth edge) face each other.

In other words, the edge E3 and the edge E4 are provided in parallel, and the edge E6 and the edge E8 are provided in parallel.

The COM substrate 4 has edges (side surfaces) E1, E2, E5, and E7 that are toward left, right, top, and bottom of the sheet, respectively (see (a) of FIG. 1 and (a) of FIG. 3). The edge E1 (first edge) and the edge E2 (second edge) face each other. The edge E5 (fifth edge) and the edge E7 (seventh edge) face each other.

In other words, the edge E1 and the edge E2 are provided in parallel, and the edge E5 and the edge E7 are provided in parallel.

The edges E1, E2, E5, and E7 are provided along the edges E3, E4, E6, and E8, respectively.

In other words, the functional panel FP has four edges, i.e., (i) the edges E1 and E3 provided along the edge E1, (ii) the edges E2 and E4 provided along the edge E2, (iii) the edges E5 and E6 provided along the edge E5, and (iv) the edges E7 and E8 provided along the edge E7.

The edge E6 has an inlet LE from which a liquid crystal is to be injected. The functional panel FP can be filled with the liquid crystal by use of a typical method for injecting a liquid crystal. For example, the SEG substrate 3 and the COM substrate 4 are combined together via a sealant, and then a space between the SEG substrate 3 and the COM substrate 4 is filled with the liquid crystal by use of a vacuum injection method.

As described later, the SEG substrate 3 and the COM substrate 4 are each provided with (i) comb-like electrodes for controlling a parallax barrier and (ii) main wiring lines connected to the comb-like electrodes. Note that how the comb-like electrodes and the main wiring lines are configured will be described later in detail.

The SEG substrate 3 has a terminal section TA via which the main wiring lines are connected to an external device. The terminal section TA and the main wiring lines are connected with each other.

The terminal section TA is provided in the vicinity of the edge E8 which is one of the edges of the SEG substrate 3. The terminal section TA is connected to an FPC (not illustrated). The functional-panel-specific driver FD transmits, via the FPC, a signal for controlling the driving of the functional panel FP.

Note that the functional panel FP and the display panel LP, which are to be combined together, have the side (edge E8) having the terminal section TA and the side having a terminal section (not illustrated), respectively, both of which sides face the same direction. For example, the source driver SD, the gate driver GD, and the printed circuit board are connected to the terminal section of the display panel LP. Since the terminal section of the display panel LP and the terminal section of the functional panel FP are provided on the same side, it is made possible to shorten a length of wiring that connects the display control circuit DCC to the panels (the functional panel FP and the display panel LP).

Since the SEG substrate 3 has the terminal section TA, the edge E8 of the four edges is provided, when viewed from above, so as to project from the edge E7 of the COM substrate 4.

In contrast, the other edges E3, E6, and E4, are provided, when viewed from above, so that the edges E3, E6, and E4 (other than the edge E8) of the SEG substrate 3 are provided inside (toward image-display-section sides of) the edges E1, E5, and E2 of the COM substrate 4, respectively.

The functional panel FP is thus configured so that (i) the COM substrate 4, which is provided farther from the display panel LP than the SEG substrate 3 is, has the edges E1 and E2 facing each other and (ii) the SEG substrate 3, which is provided closer to the display panel LP than the COM substrate 4 is, has (a) the edge E3 provided, when viewed from above, along and inside the edge E 1 and (b) the edge E4 provided, when viewed from above, along and inside the E2 when viewed from above.

The functional panel FP is configured so that (i) the COM substrate 4 has the edge E5 which is adjacent to one end of each of the edges E 1 and E2 and (ii) the SEG substrate 3 has the edge E7 provided, when viewed from above, along and inside the edge E5.

Hence, a step D1 is formed by the edges E1 and E3, a step D2 is formed by the edges E2 and E4, and a step D3 is formed by the edges E5 and E6.

Therefore, when the functional panel FP and the display panel LP are combined together via the adhesive BO, part of the adhesive BO is pressed out and then flows into the steps D1, D2, and D3. With the functional panel FP, it is therefore possible to prevent the adhesive BO from being pressed out of the display panel LP. This makes it possible to prevent defects in an external shape of the display unit 101.

The functional panel FP includes two substrates: the COM substrate 4 and the SEG substrate 3. This makes it possible to secure at least a distance, between the COM substrate 4 and the display panel LP, which is equal to a thickness of the SEG substrate 3.

This allows spaces, which are sufficiently large for the adhesive BO to flow into, to be secured around the steps D1, D2, and D3 when the functional panel FP and the display panel LP are combined together via the adhesive BO.

It is therefore possible for the configuration of the functional panel FP to more reliably prevent the adhesive BO from being pressed out of the panel, as compared with a configuration employing a single substrate. This makes it possible to prevent the defects in the external shape of the display unit 101.

Since the steps D1, D2, and D3 can be easily provided, it is further possible to prevent defective products from being produced. This allows an increase in production costs to be prevented.

As described above, the functional panel FP need only have the steps D1, D2, and D3. Furthermore, such steps D1, D2, and D3 can be formed during a process in which a plurality of functional panels FP provided on a mother glass are divided into individual pieces. This eliminates the necessity of adding chamfering for providing the cut-out part 520a on the parallax barrier substrate 520, unlike the conventional technology of Patent Literature 1 described with reference to FIG. 20. It is therefore possible to prevent an increase in production costs.

Note in the technology of Patent Literature 1 that it is difficult to form a cut-out part 520a on a thin parallax barrier substrate 520. This causes an increase in defect rate, and ultimately results in an increase in production costs.

According to the display unit 101, on the other hand, it is possible as described above to form the steps D1, D2, and D3 by dividing, into individual pieces, a plurality of functional panels FP provided on a mother glass. It follows that there is no difficult step involved. This makes it possible to suppress an increase in production costs.

As an example, the step D1 formed by the edges E1 and E3 (distance between the edges E1 and E3) is 0.2 mm; the step D2 formed by the edges E2 and E4 (distance between the edges E2 and E4) is 0.2 mm; and the step D3 formed by the edges E5 and E6 (distance between the edges E5 and E6) is 0.05 mm.

The functional panel FP need only include at least one of the steps D1, D2, and D3. This allows the adhesive BO to flow into any of the D1, D2, and D3. It is therefore possible to bring about an effect of preventing the defects in the external shape of the display unit 101.

Note also that, even small steps D1, D2, and D3, which are formed by the edges E1 and E3, the edges E2 and E4, and the edges E5 and E6, respectively, still allow the adhesive BO to flow into the small steps D1, D2, and D3. This brings about an effect of preventing the defects in the external shape of the display unit 101.

Note, however, that it is preferable for each of the steps D1, D2, and D3 to have a length of 0.05 mm or more so that the steps D1, D2, and D3 are certainly formed by the edges E1 and E3, the edges E2 and E4, and the edges E5 and E6, respectively. This allows the steps D1, D2, and D3 to be definitely formed by the edges E1 and E3, the edges E2 and E4, and the edges E5 and E6, respectively, even in view of accuracy (processing accuracy) in a process of dividing COM substrates 4 and SEG substrate 3 from a mother glass.

An upper limit of the length of each of the steps D1, D2, and D3 is preferably large, from the perspective that the functional panel FP is firmly fixed by bringing the adhesive BO into contact with a back surface (surface facing the display panel LP) of part of the COM substrate 4 which part is located outside the edges E3, E6, and E4 of the SEG substrate 3.

Note, however, that each of the edges E3, E4, and E6 is preferably located outside, by at least 0.05 mm, the image display section of the display panel LP when viewed from above. This is because the functional panel FP and the display panel LP should be combined together by taking into consideration an accuracy of combining the functional panel FP and the display panel LP together.

Note also that each location of the edges E3, E4, and E6 of the functional panel FP needs to be suitably determined by taking into consideration (i) a wiring region on the SEG substrate 3 and (ii) a sealing region (described later) by which the functional panel FP and the display panel LP are combined together. The details will be described later.

As described earlier, since the terminal section TA is provided on the SEG substrate 3, the edge E8 is provided outside the edge E6 of the COM substrate 4.

Note that a part of the display panel LP, which part faces the edge E8, has another step. Specifically, an edge of the counter substrate 1 is located inside an edge of the active matrix substrate 2. This causes the another step to be formed. In a region where the another step is formed, for example, (i) the source driver SD and the gate driver GD are provided and (ii) the printed circuit is connected. Even if the adhesive BO flows out from the edge E8 side, the adhesive BO flows into the another step of the display panel LP. As such, there occurs no defective external shape of the display unit 101.

The functional panel FP is configured so that the edge E6 has the inlet LE. This causes the step D3, which is formed by the edge E6 and the edge E5, to be smaller than (i) the step D1 formed by the edges E1 and E3 and (ii) the step D2 formed by the edges E2 and E4. Note that the edges E1 and E3 correspond to the respective left edges and the edges E2 and E4 correspond to the respective right edges of the display unit 101 (see (a) of FIG. 1 and (a) of FIG. 3). For example, the steps D1 and D2 each have a height of 0.2 mm, and the step D3 has a height of 0.05 mm. This makes it possible to prevent a decrease in productivity during the process of sealing the inlet LE.

The display panel LP has, when viewed from above, (i) an edge 21 provided along and outside the edge E 1 and (ii) an edge 22 provided along and outside the edge E2.

Hence, the adhesive BO is unlikely to flow out of the display panel LP, and it is therefore possible to suppress defects in the external shape of the display unit 101.

According to the functional panel FP, four edges of the polarizing plate 5 are provided, when viewed from above, inside the edges E3, E6, E4, and E8 of the SEG substrate 3.

Specifically, the polarizing plate 5 has, when viewed from above, (i) an edge 5E1 provided inside the edge E3, (ii) an edge 5E2 provided inside the edge E4, (iii) an edge 5E3 provided inside the edge E6, and (iv) an edge 5E4 provided inside the edge E8.

This causes the adhesive BO to be in contact with not only the polarizing plate 5 but also the counter substrate 1 which is provided outside the edges 5E1, 5E2, 5E3, and 5E4, when viewed from above. This allows the functional panel FP and the display panel LP to be more firmly fixed to each other.

Note that it is possible for the adhesive BO to be in contact with the counter substrate 1 by causing at least one of the edges 5E1, 5E2, 5E3, and 5E4 of the polarizing plate 5 to be provided inside a corresponding one of the edges E3, E6, E4, and E8 of the SEG substrate 3. This allows the functional panel FP and the display panel LP to be more firmly fixed to each other.

Note also that the polarizing plate 5 need only be provided between the counter substrate 1 and the SEG substrate 3. That is, the polarizing plate 5 can be provided on, instead of the front surface of the counter substrate 1, the back surface of the SEG substrate 3 (surface facing the display panel LP).

As illustrated in (a) through (c) of FIG. 1, the adhesive BO has pressed-out parts BOa that stick out, when viewed from above, of the edges E3, E6, and E4 of the display unit 101. The pressed-out parts BOa are located on the front surface of the display panel LP, and do not stick out of the display panel LP. In other words, since the display unit 101 has the steps D1, D2, and D3, it is possible to prevent the pressed-out parts BOa from sticking out of the display panel LP.

The pressed-out parts BOa are in contact with the COM substrate 4 via the steps D1, D2, and D3. This allows the functional panel FP and the display panel LP to be more firmly fixed to each other, and therefore makes it possible to obtain a display unit 101 that is highly shock resistant.

Note that the pressed-out part BOa of the adhesive BO need only stick out, when viewed from above, of at least one of the edges E3, E6, and E4 so as to be in contact with the back surface of the COM substrate 4.

Alternatively, it is possible to configure the adhesive BO as illustrated in FIG. 7.

(a) of FIG. 7 is a plan view illustrating another configuration of a display unit 101 in accordance with Embodiment 1. (b) of FIG. 7 is a cross-sectional view taken along the line A-A′ illustrated in (a) of FIG. 7. (c) of FIG. 7 is a cross-sectional view taken along the line B-B′ illustrated in (a) of FIG. 7.

As illustrated in (a) through (c) of FIG. 7, pressed-out parts BOa of an adhesive BO do not need to be in contact with a COM substrate 4 via steps D1, D2, and D3.

As illustrated in (a) through (c) of FIG. 7, the display unit 101 is configured so that a distance between a polarizing plate 5 and an SEG substrate 3 is shorter than a distance between a counter substrate 1 and a COM substrate 4. Therefore, in a case where the pressed-out parts BOa become in contact with the back surface of the COM substrate 4 via the steps D1, D2, and D3, a functional panel FP or a display panel LP bends due to a difference in contraction amount between (i) lateral end parts of the adhesive BO (including the pressed-out parts BOa) and (ii) the rest of the adhesive BO. This causes a deterioration in display quality of the display unit 101.

In view of the circumstances, by employing a configuration in which the pressed-out parts BOa are not in contact with the COM substrate 4 via the steps D1, D2, and D3, it is possible to combine the counter substrate 1 and the COM substrate 4 together such that the distance between the counter substrate 1 and the COM substrate 4 is less affected even in a case where a difference in contraction amount between (i) the lateral end parts of the adhesive BO (including the pressed-out parts BOa) and (ii) the rest of the adhesive BO. This causes the amount of the flexure of the functional panel FP or the display panel LP to be low, and therefore allows prevention of degrading of the display quality of the display unit 101.

(SEG Electrode and COM Electrode)

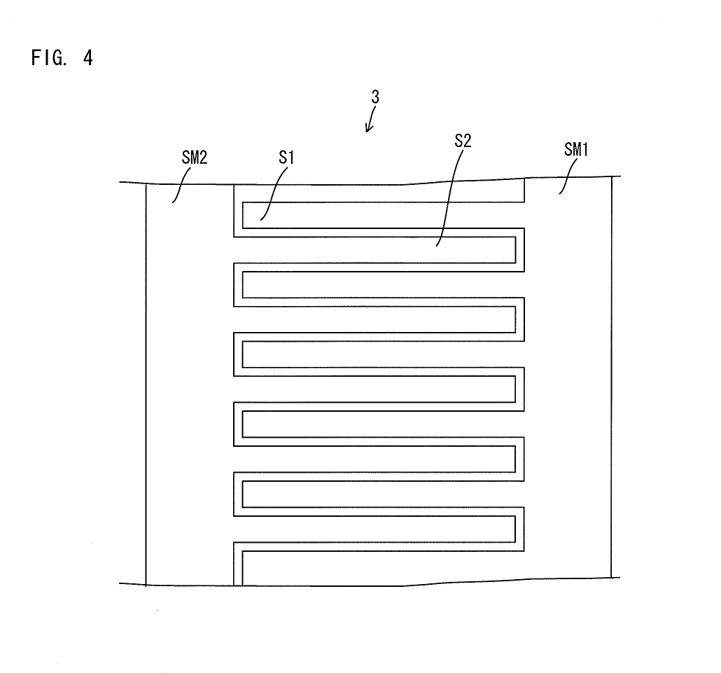

Configurations of electrodes provided on the SEG substrate 3 and the COM substrate 4 will be described below with reference to FIGS. 4 through 6.

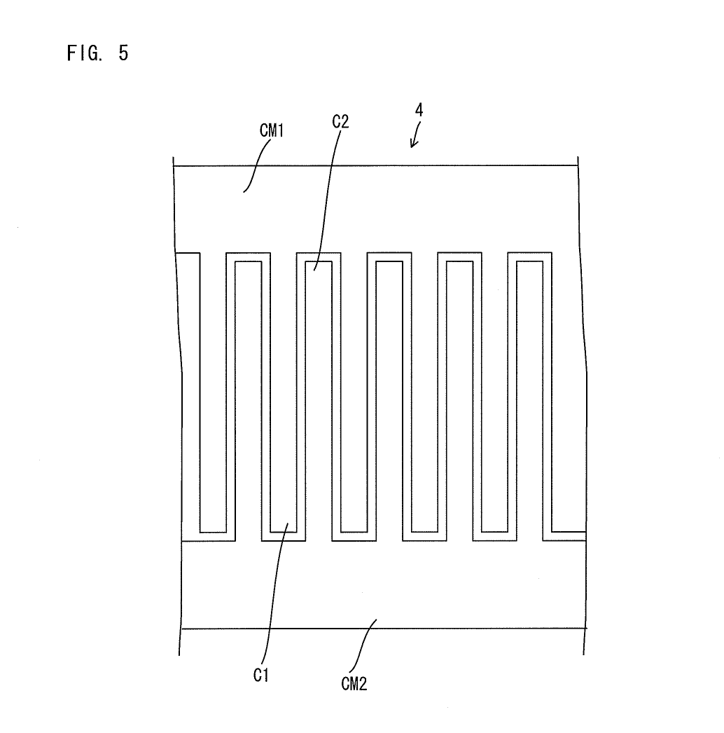

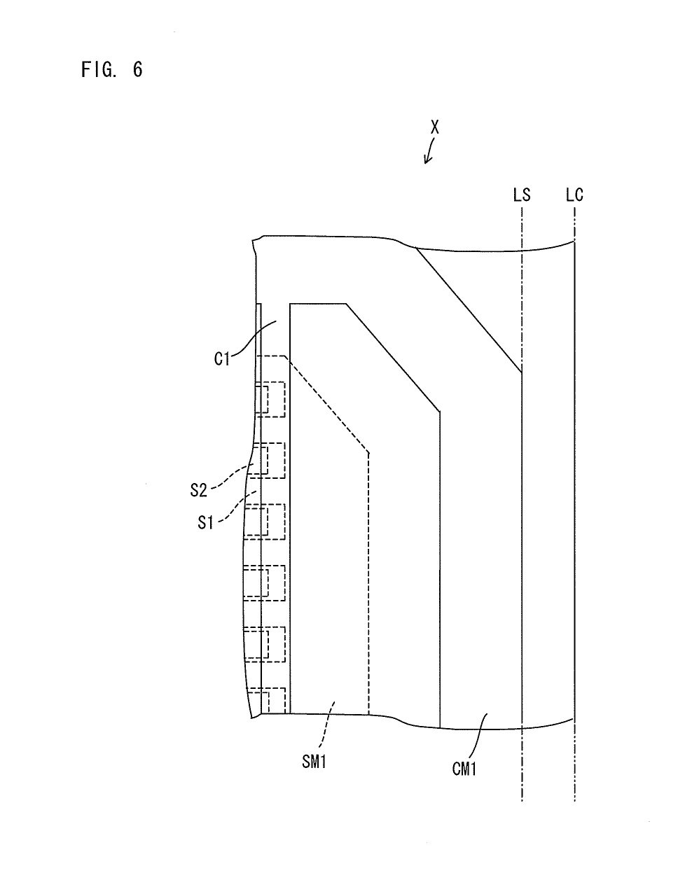

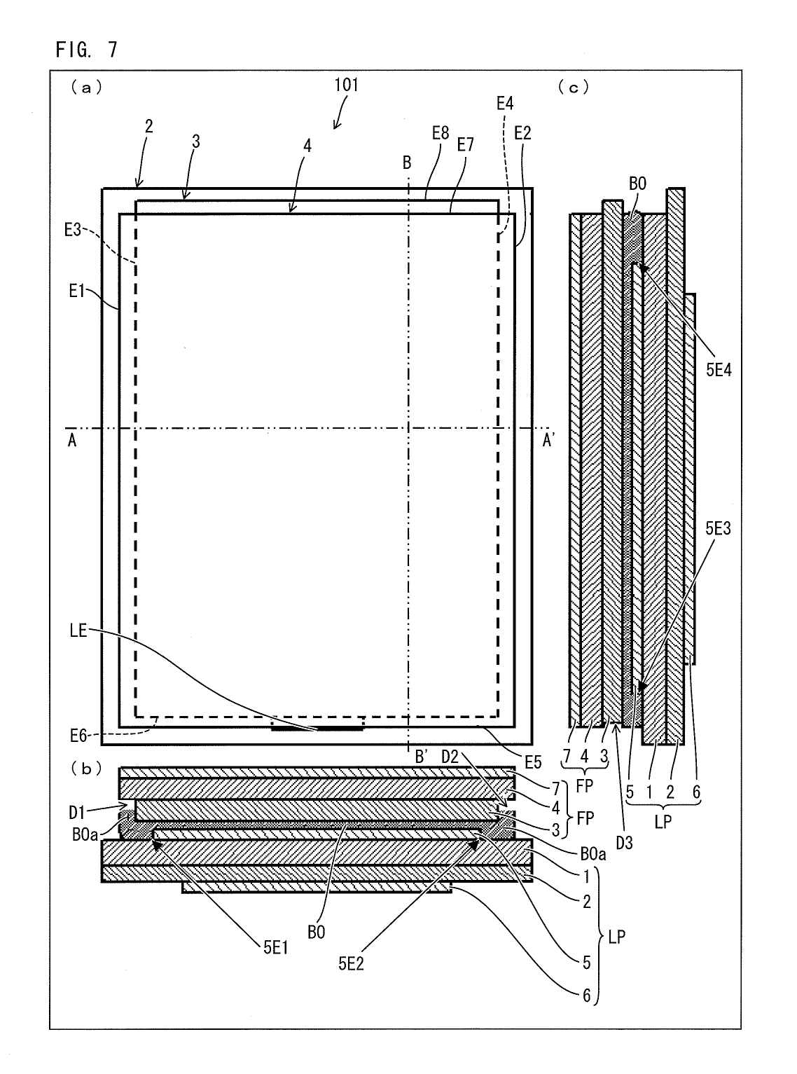

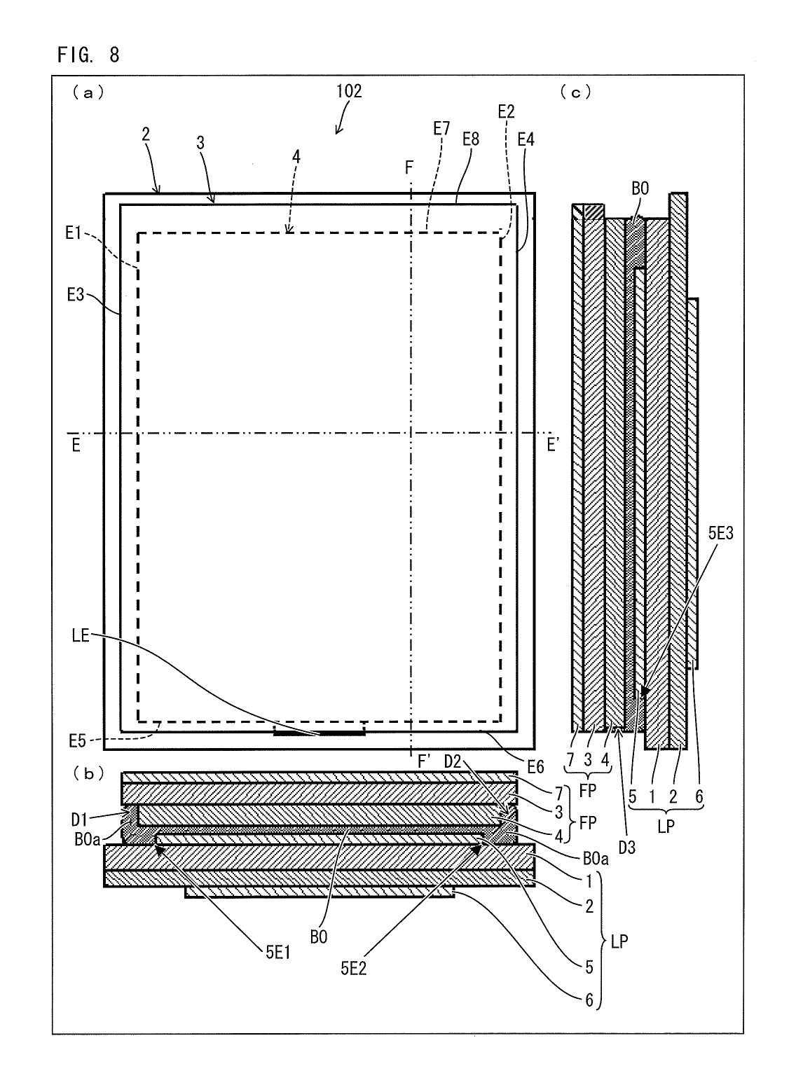

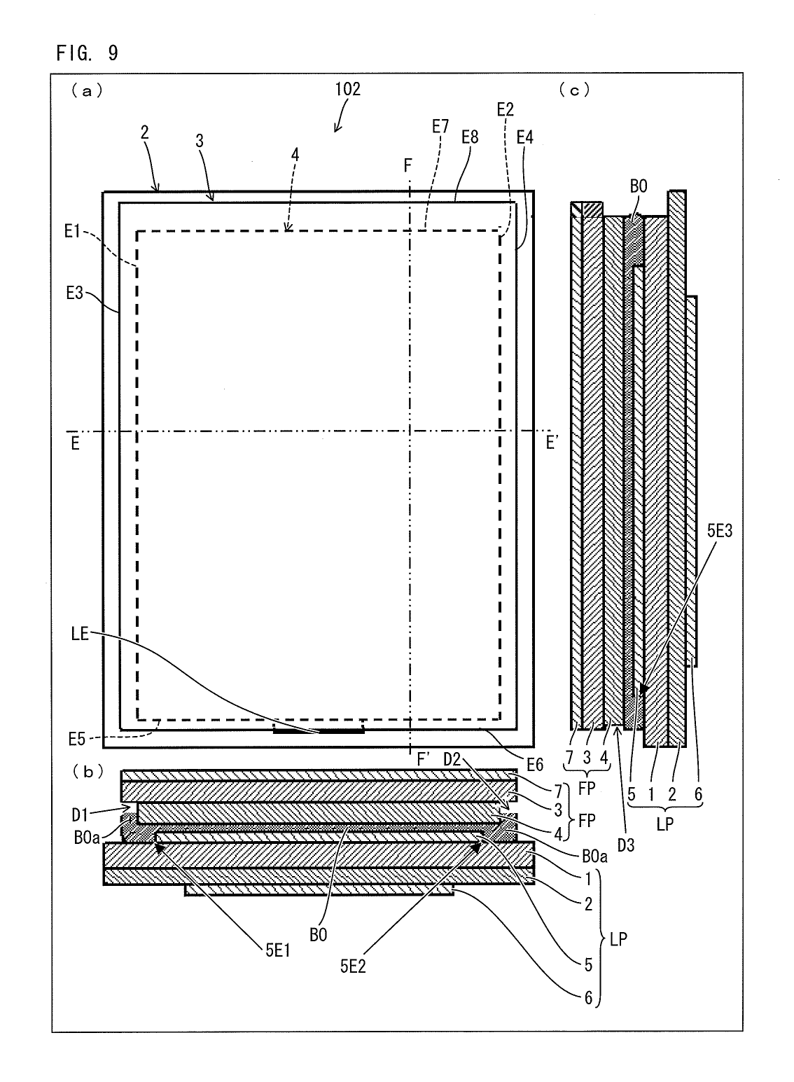

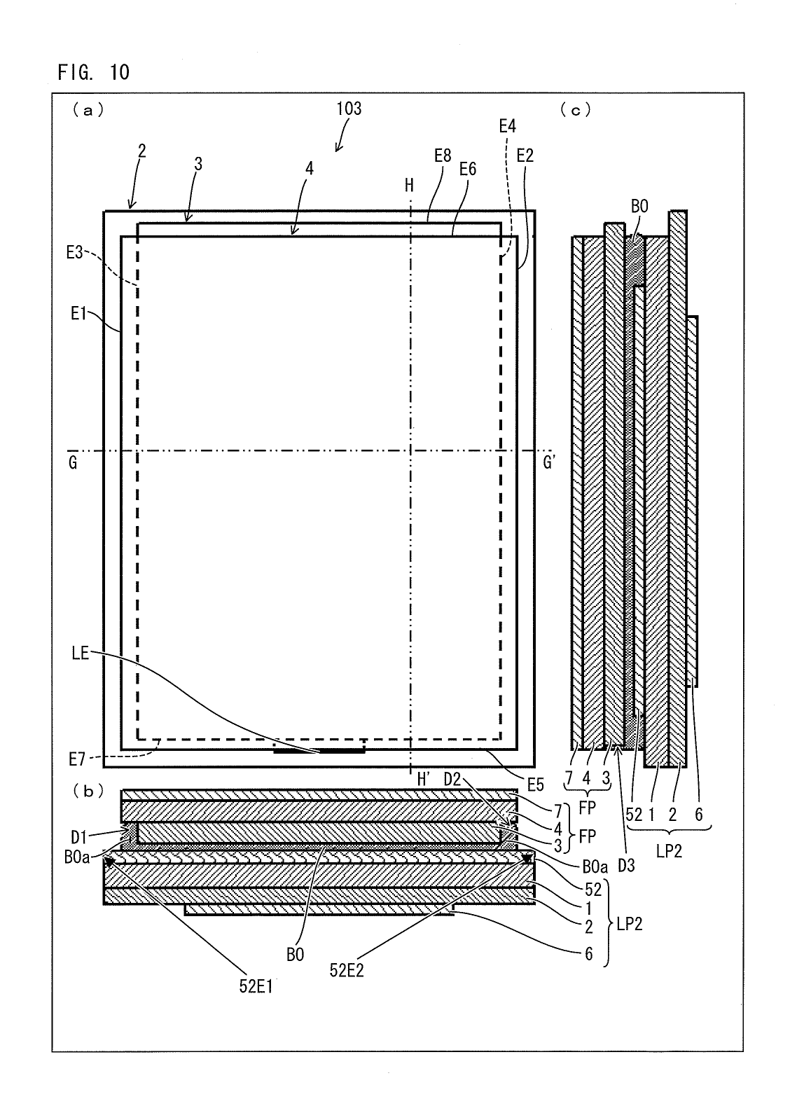

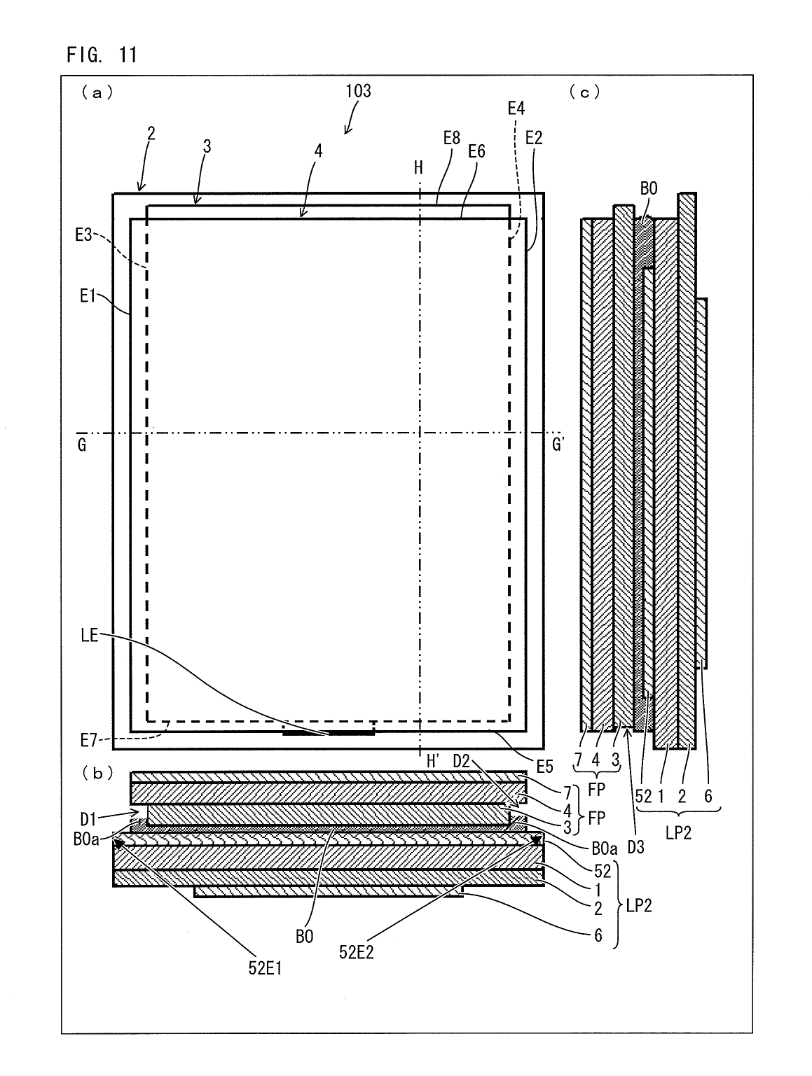

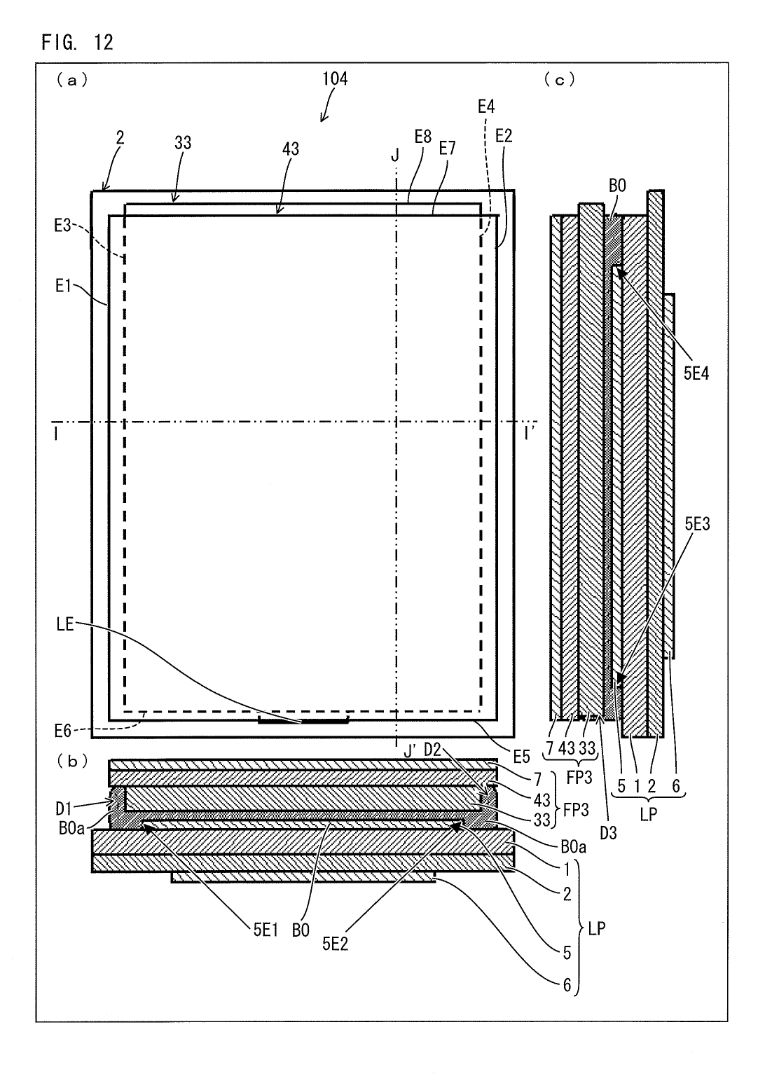

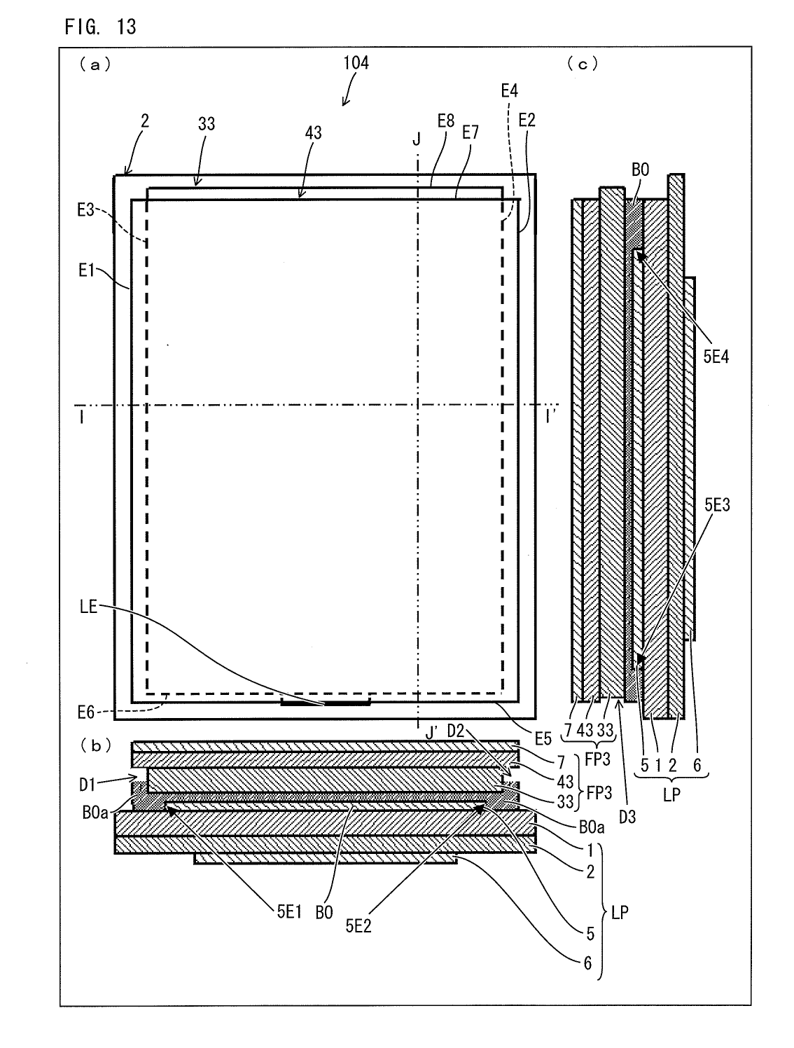

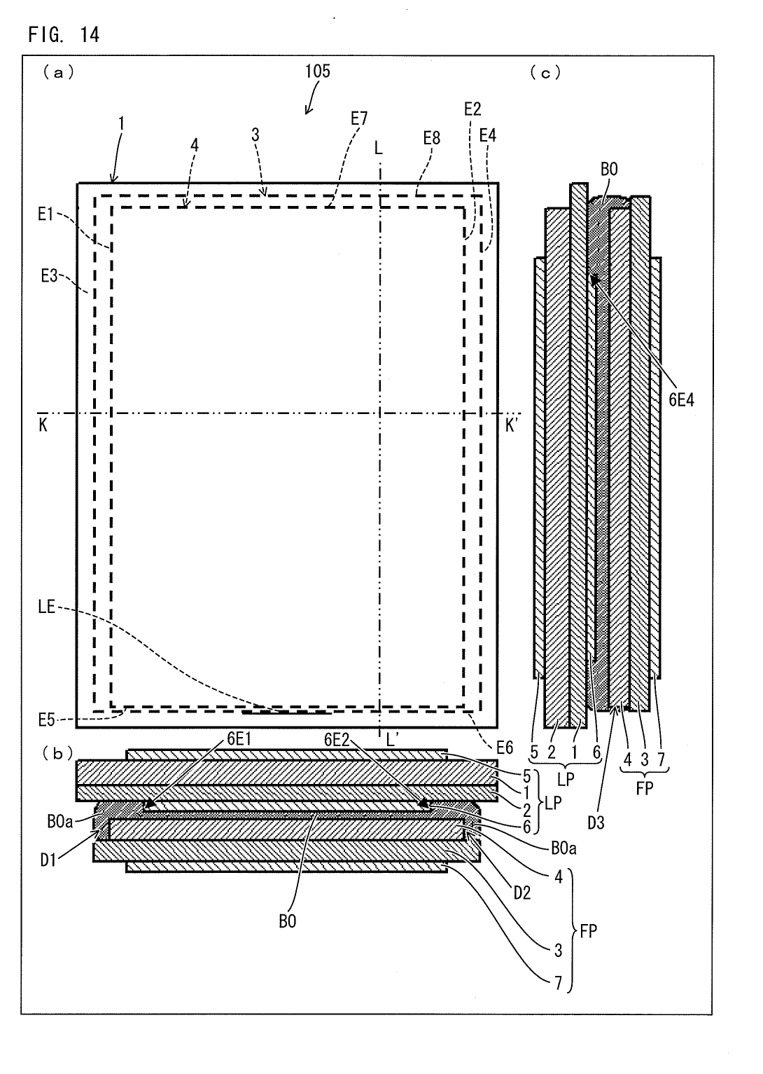

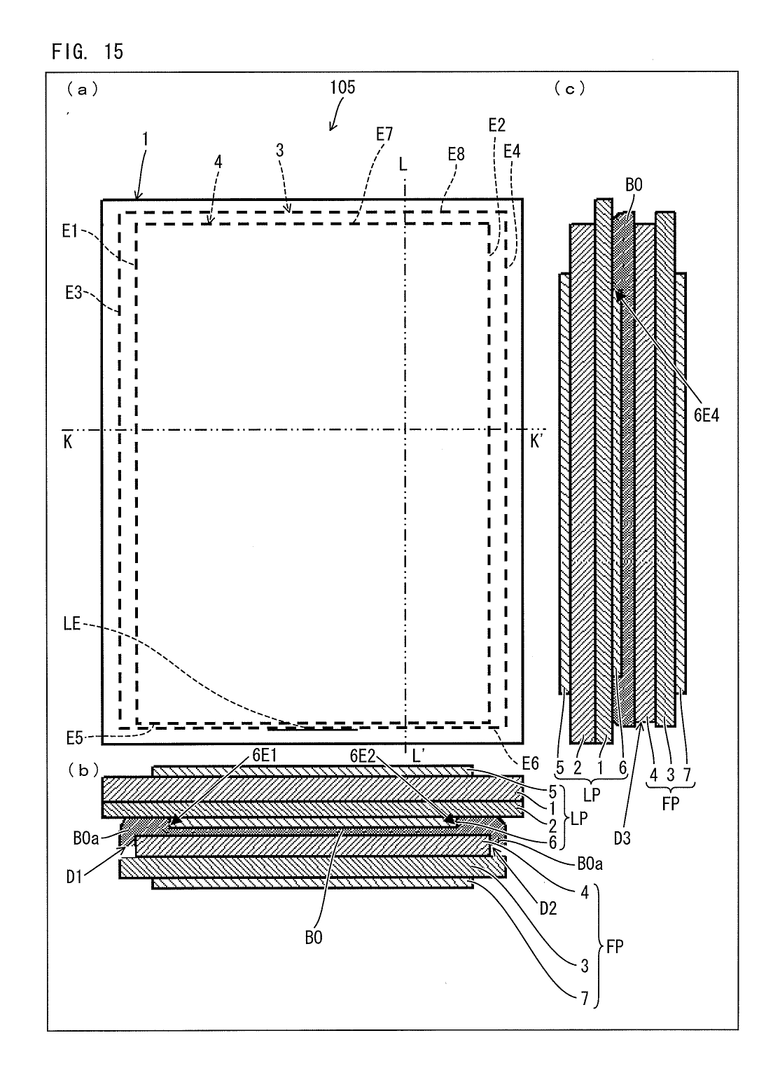

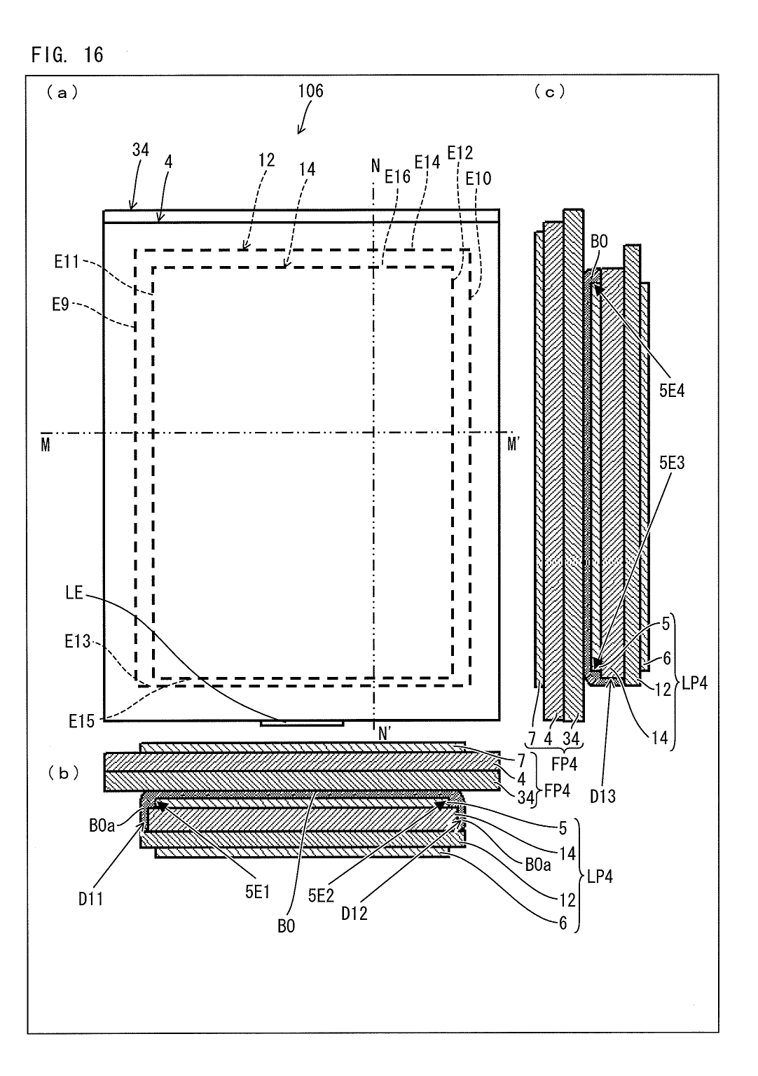

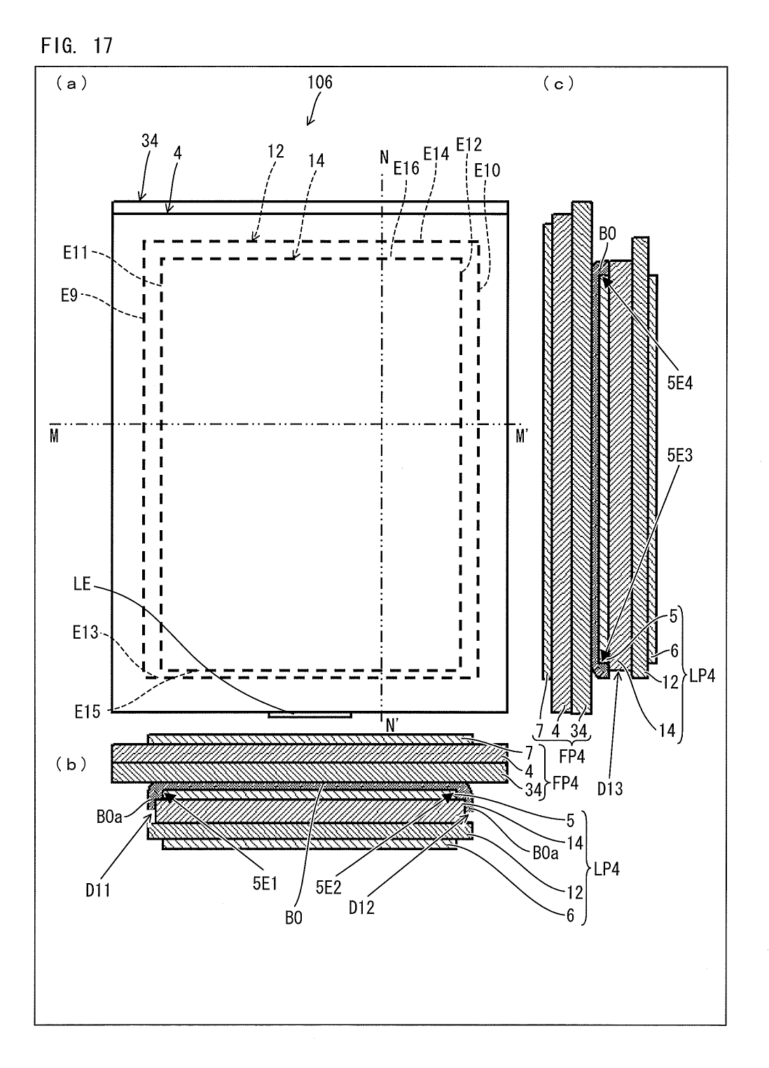

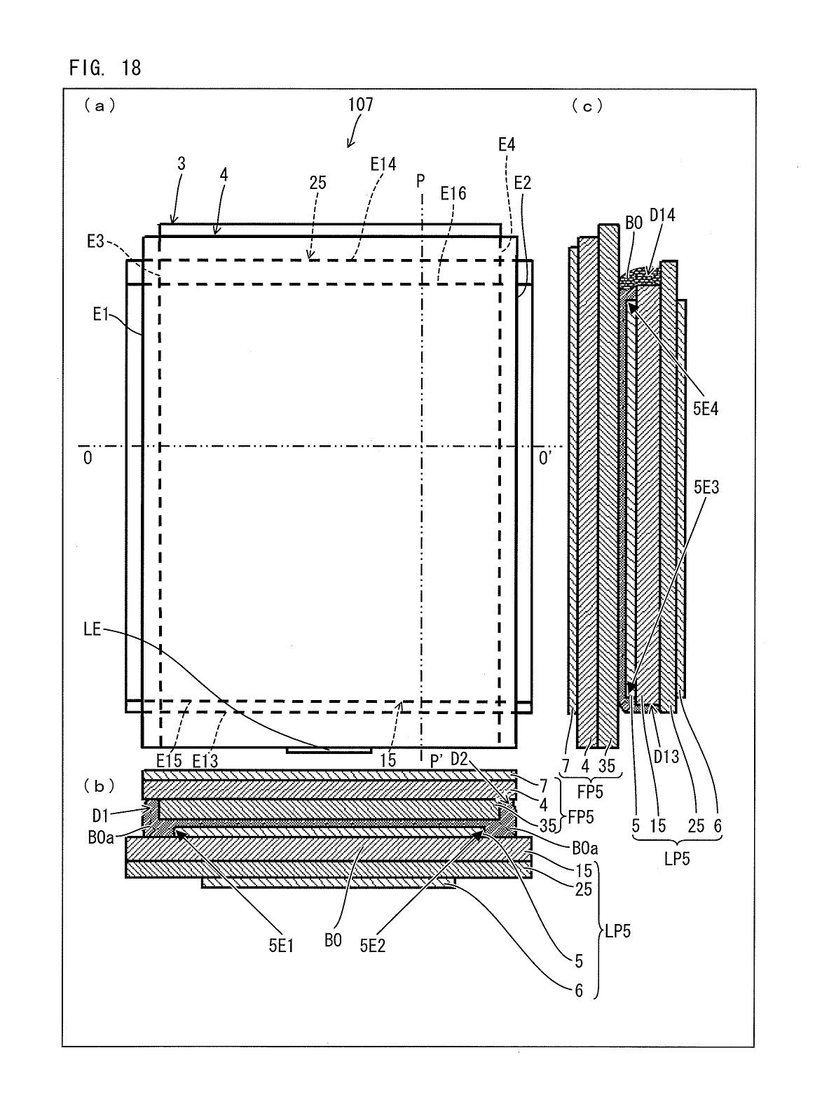

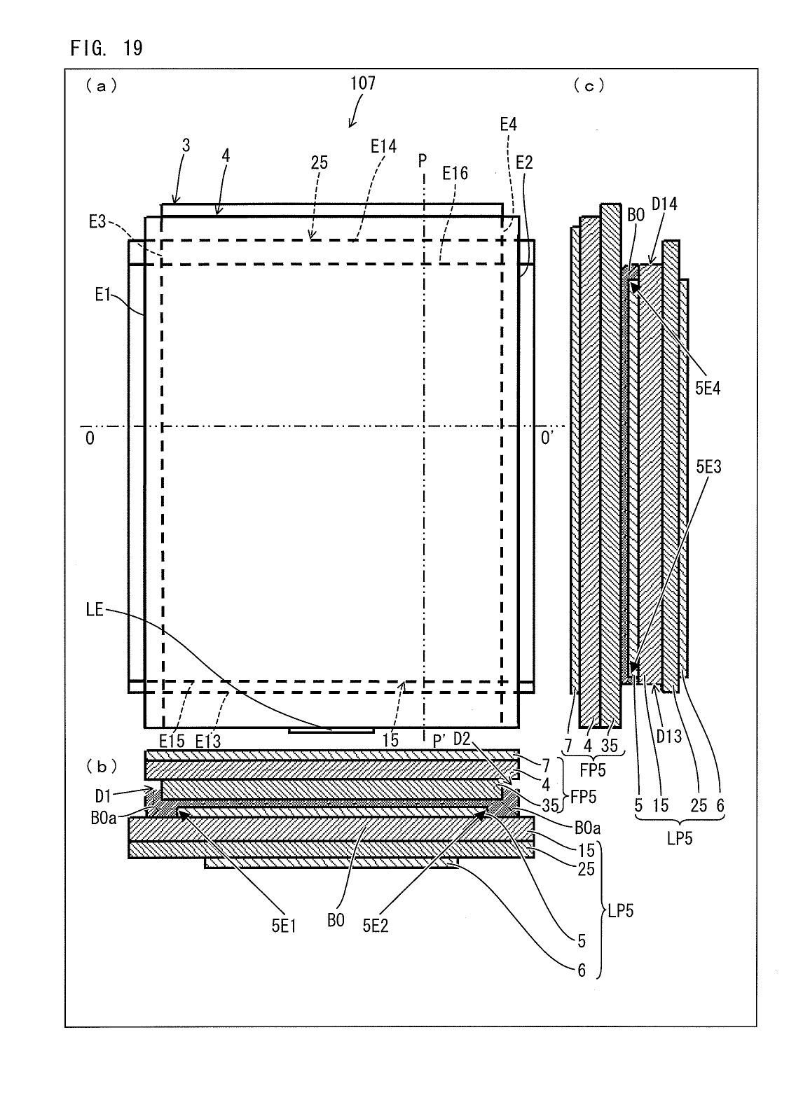

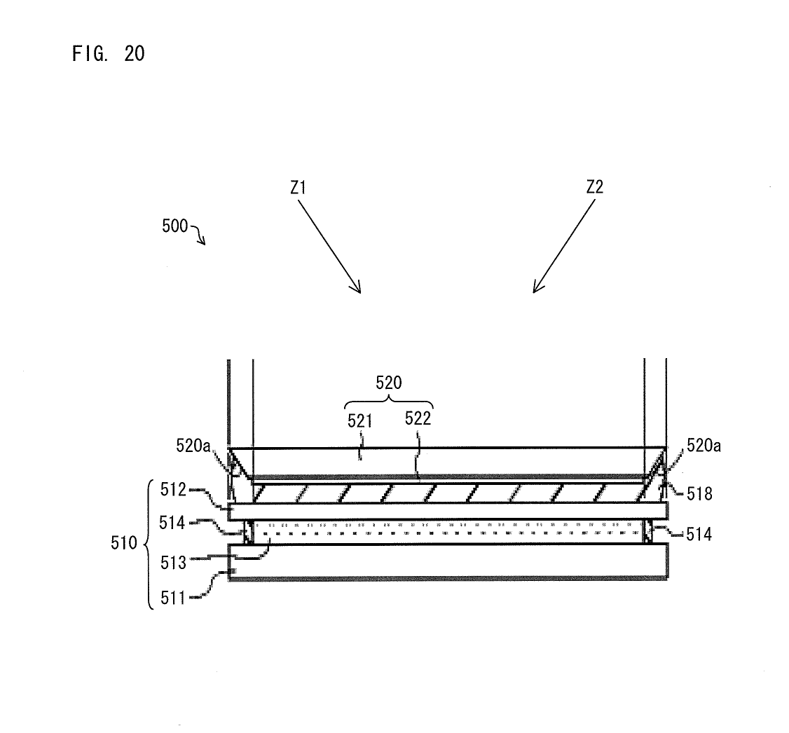

FIG. 4 is a plan view illustrating the configuration of SEG electrodes provided on the SEG substrate 3. FIG. 5 is a plan view illustrating the configuration of COM electrodes provided on the COM substrate 4. FIG. 6 is an enlarged view of a region X illustrated in FIG. 3.

As illustrated in FIG. 4, the SEG substrate 3 includes a glass substrate, SEG electrodes S1 and S2 provided on the glass substrate, and main wiring lines SM1 and SM2 provided on the glass substrate.

Specifically, the SEG substrate 3 includes (i) third comb-like electrodes made up of the SEG electrodes (teeth part of the third comb-like electrodes) S1 and the main wiring line (main part of the third comb-like electrodes) SM1 and (ii) fourth comb-like electrodes made up of the SEG electrodes (teeth part of the fourth comb-like electrodes) S2 and the main wiring line (main part of the fourth comb-like electrodes) SM2.

On the SEG substrate 3, the SEG electrodes (teeth part of the third comb-like electrodes) S1 and the SEG electrodes (teeth part of the fourth comb-like electrodes) S2 are provided so as to mesh with each other but without being in touch with each other.

Specifically, the SEG electrodes S1 and S2 are (i) each made up of a plurality of wiring lines linearly extending in parallel and (ii) arranged by the wiring lines of the SEG electrodes S1 and the wiring lines of the SEG electrodes S2 alternately provided (so as to mesh with each other). Thus, the SEG electrodes S1 and the SEG electrodes S2 can receive respective signals differing from each other.

The main wiring line (main part of the third comb-like electrodes) SM1 is connected with one end parts of the respective SEG electrodes S1 (right end parts of the respective SEG electrodes S1 in FIG. 4). That is, any adjacent one end parts of the SEG electrodes S1 are connected with each other via the main wiring line SM1. The main wiring line SM1 extends in a direction in which the SEG electrodes S1 are juxtaposed.

The main wiring line (main part of the third comb-like electrodes) SM2 is connected with one end parts of the respective SEG electrodes S2 (left end parts of the respective SEG electrodes S2 in FIG. 4). That is, any adjacent one end parts of the SEG electrodes S2 are connected with each other via the main wiring line SM2. The main wiring line SM2 extends in a direction in which the SEG electrodes S2 are juxtaposed.

Depending on the number of the SEG electrodes S1, the main wiring lines SM1 may or may not be divided into, for example, two, i.e., one is for upper (upper half of) SEG electrodes S1 of FIG. 4 and the other is for lower (lower half of) SEG electrodes S1. Similarly, depending on the number of the SEG electrodes S2, the main wiring lines SM2 may or may not be divided into, for example, two, i.e., one is for upper (upper half of) SEG electrodes S2 of FIG. 4 and the other is for lower (lower half of) SEG electrodes S2.

As illustrated in FIG. 5, the COM substrate 4 includes a glass substrate, COM electrodes C1 and C2 provided on the glass substrate, and the main wiring lines CM1 and CM2 provided on the glass substrate.

Specifically, the COM substrate 4 includes (i) first comb-like electrodes made up of the COM electrodes (teeth part of the first comb-like electrodes) C1 and the main wiring line (main part of the third comb-like electrodes) CM1 and (ii) second comb-like electrodes made up of the COM electrodes (teeth part of the second comb-like electrodes) C2 and the main wiring line (main part of the second comb-like electrodes) CM2.

On the COM substrate 4, the COM electrodes (teeth part of the first comb-like electrodes) C1 and the COM electrodes (teeth part of the second comb-like electrodes) C2 are provided so as to mesh with each other but without being in touch with each other.

The COM electrodes C1 and C2 are (i) each made up of a plurality of wiring lines linearly extending in parallel and (ii) arranged by the wiring lines of the COM electrodes C1 and the wiring lines of the COM electrodes C2 alternately provided (so as to mesh with each other). Thus, the COM electrodes C1 and the COM electrodes C2 can receive respective signals differing from each other.

The main wiring line (main part of the first comb-like electrodes) CM1 is connected with one end parts of the respective COM electrodes C1 (top end parts of the respective COM electrodes C1 in FIG. 5). That is, any adjacent one end parts of the COM electrodes C1 are connected with each other via the main wiring line CM1. The main wiring line CM1 extends in a direction in which the COM electrodes C1 are juxtaposed.

The main wiring line (main part of the second comb-like electrodes) CM2 is connected with one end parts of the respective COM electrodes C2 (bottom end parts of the respective COM electrodes C2 in FIG. 5). That is, any adjacent one end parts of the COM electrodes C2 are connected with each other via the main wiring line CM2. The main wiring line CM2 extends in a direction in which the COM electrodes C2 are juxtaposed.

The SEG substrate 3 supplies a signal to the COM electrodes C1 and C2 via common transferring means as is the case of a known common technology for a liquid crystal panel.

The SEG substrate 3 is thus provided with the SEG electrodes S1 and S2 that mesh with each other, and the COM substrate 4 is thus provided with the COM electrodes C1 and C2 that mesh with each other. This causes the functional panel FP to function as a panel for a parallax barrier by causing a voltage to be generated between the SEG electrodes S1 and S2 or between the COM electrodes C1 and C2.

As illustrated in FIG. 6, a direction in which the COM electrodes C1 and C2 extend and a direction in which the SEG electrodes S1 and S2 extend are orthogonal to each other when viewed from above. That is, there is a 90° difference between (i) the direction in which the COM electrodes C1 and C2 extend and (ii) the direction in which the SEG electrodes S1 and S2 extend.

Hence, in a case where (i) the display unit 101 of the display device 100 is arranged in a direction (first direction) so that an extending direction of the COM electrodes C1 and C2 matches a vertical direction, (ii) a voltage is caused to be generated between the COM electrodes C1 and C2, and (iii) the SEG electrodes S1 and S2 maintain a constant electric potential, it is possible for the functional panel FP to have a parallax barrier in which the extending direction matches the vertical direction. This allows the display unit 101 to display a 3D image.

On the other hand, in a case where (i) the display unit 101 of the display device 100 is arranged in a direction (second direction) so that an extending direction of the SEG electrodes S1 and S2 matches a vertical direction, (ii) a voltage is caused to be generated between the SEG electrodes S1 and S2, and (iii) the COM electrodes C1 and C2 maintain a constant electric potential, it is possible (as in the case of the first direction) for the functional panel FP to have a parallax barrier in which the extending direction matches the vertical direction. This allows the display unit 101 to display a 3D image.

Since 3D image display is thus possible regardless of whether the display unit 101 is arranged in the first or second direction, it is possible to provide a highly versatile display device 100.

According to Embodiment 1, by properly supplying parallax barrier controlling signals to (i) the SEG electrodes S1 and S2 and (ii) the COM electrodes C1 and C2, it is thus possible to not only enable or disable a parallax barrier but also switch between parallax barriers (i) of a display unit 101 arranged in a longitudinal direction (first direction) and (ii) of a display unit 101 arranged in lateral direction (second direction) that is at a 90° angle to the longitudinal direction.

With the functional panel FP configured as such, it is possible to provide a display device 100 capable of displaying a 3D image regardless of whether the display device 100 is used longitudinally or laterally.

Depending on the number of the COM electrodes C1, the main wiring lines CM1 may or may not be divided into, for example, two, i.e., one is for right (right half of) COM electrodes C1 of FIG. 5 and the other is for left (left half of) COM electrodes C1. Similarly, depending on the number of the COM electrodes C2, the main wiring lines CM2 may or may not be divided into, for example, two, i.e., one is for right (right half of) COM electrodes C2 of FIG. 5 and the other is for left (left half of) COM electrodes C2.

Electrodes to be provided on the functional panel FP do not necessarily need to be the comb-like SEG electrodes S1 and S2 and the comb-like COM electrodes C1 and C2 which are provided on the SEG substrate 3 and the COM substrate 4, respectively.

In a case of a configuration in which a parallax barrier merely extending in one direction (either the first or second direction) is obtained, (i) the COM electrodes C1 and C2 can each be a solid electrode (flat electrode that is not comb-like patterned) and (ii) only one of the SEG electrodes S1 and S2 needs to be used.

In such a case, since the main wiring lines CM1 and CM2 are not provided on the COM substrate 4, it is possible to increase an amount of the SEG substrate 3 to cut off to form the edges E3, E7, and E4 so as to ultimately form the steps D1, D2, and D3. This allows even a larger amount of adhesive BO to flow into the steps D1, D2, and D3, and therefore makes it possible to even more reliably prevent the defects in the external shape of the display unit 101.

Note that the main wiring lines SM1 and SM2 and the main wiring lines CM1 and CM2 are provided in the vicinity of the edges E1 and E3 and the edges E2 and E4 of the functional panel FP.

Note that the functional panel FP is configured so that neither the main wiring lines CM1 nor CM2 covers (overlaps) the main wiring lines SM1 or SM2 when viewed from above.

The functional panel FP is configured so that the edge E4 (edge LS illustrated in FIG. 6) of the SEG substrate 3 is provided inside the edge E2 (edge LC illustrated in FIG. 6) of the COM substrate 4. Hence, the main wiring lines CM1, CM2, SM1, and SM2 are to be provided so that the main wiring lines SM1 and SM2 are located inside the main wiring lines CM1 and CM2 when viewed from above. This makes it possible to reduce, in the functional panel FP, a load caused by, for example, parasitic capacitance between (i) the main wiring lines CM1 and CM2 and (ii) the main wiring lines SM1 and SM2.

A sealant (not illustrated) is provided in the vicinity of the main wiring lines CM1 and CM2 and the main wiring lines SM1 and SM2, and the SEG substrate 3 and the COM substrate 4 are combined together via the sealant. In some cases, the sealant contains an electrically conductive material that causes the COM electrodes to be electrically connected, via common transferring means, to the SEG electrodes. In such cases, when (i) the main wiring lines CM1 and CM2 and (ii) the main wiring lines SM1 and SM2 overlap each other, the sealant may induce electrical conduction failure.

In view of the circumstances, the main wiring lines CM1 and CM2 are each provided so as not to cover the main wiring lines SM1 or SM2. This makes it possible to prevent the electrical conduction failure from occurring via the sealant.

In addition, the COM electrodes C1 and C2 and the main wiring lines CM1 and CM2 are each provided inside the edges E3 and E4 when viewed from above. This prevents the COM electrodes C1 and C2 and the main wiring lines CM1 and CM2 from being exposed, and therefore suppresses the occurrence of malfunction caused by electrolytic corrosion and/or static electricity.

The edge E4 of the SEG substrate 3 matches part of the main wiring lines CM1 and CM2, which part is provided in the vicinity of the edge E2 of the COM substrate 4.

According to the illustration of FIG. 6, the edge LS of the SEG substrate 3 matches the edge of the main wiring line CM1 when viewed from above. By thus providing the edge E4 (edge LS illustrated in FIG. 6) of the SEG substrate 3 so that the main wiring lines CM1 and CM2 of the COM substrate 4 are prevented from being exposed, it is possible to suppress the occurrence of malfunction caused by electrolytic corrosion of the main wiring lines CM1 and CM2 and/or static electricity caused by the main wiring lines CM1 and CM2.

The edge E4 is to be provided preferably inside, in light of securing of a space to which the adhesive BO adheres. If the edge E4 is, however, provided too inside, it becomes impossible to secure (i) a region where the main wiring lines CM1 and CM2 are to be provided and/or (ii) a sealing region via which the SEG substrate 3 and the COM substrate 4 are to be combined together. Therefore, a proper location of the edge E4 is to be determined in view of delay in signal propagation etc. of the functional panel FP.

Note that a top-left part of FIG. 3 is similar to the top-right part (region X) of FIG. 3 (which was described with the use of FIG. 6) in terms of positional relationship between (i) the edge E1 of the COM substrate 4, (ii) the edge E3 of the SEG substrate 3, (iii) the main wiring lines CM1 and CM2, and (iv) the main wiring lines SM1 and SM2.

Note that the functional panel FP does not necessarily need to be a switching panel for switching between parallax barriers. Alternatively, the functional panel FP can be (i) a (veil view) switching panel for switching between wide viewing angle and narrow viewing angle, (ii) a switching panel for switching between (a) a front view and (b) right and left views (dual view), or (iii) a touch panel.

### Modification 1

A modification 1 will be described below with reference to (a) through (c) of FIG. 8.

(a) of FIG. 8 is a plan view illustrating a configuration of a display unit 102 in accordance with the modification 1 of Embodiment 1. (b) of FIG. 8 is a cross-sectional view taken along the line E-E′ illustrated in (a) of FIG. 8. (c) of FIG. 8 is a cross-sectional view taken along the line F-F′ illustrated in (a) of FIG. 8.

The display unit 102 includes a functional panel FP2 instead of the functional panel FP which was included in the display unit 101.

According to the functional panel FP2, the SEG substrate 3 of and the COM substrate 4 of the functional panel FP are reversely arranged.

The functional panel FP2 (i) includes an SEG substrate (first substrate) 3 and a COM substrate (second substrate) 4 facing each other and (ii) is to be combined with a display panel LP via an adhesive BO.

According to the functional panel FP2, the SEG substrate 3 (i) is provided farther from the display panel LP than the COM substrate 4 is and (ii) has an edge (first edge) E3 and an edge (second edge) E4 facing each other. The SEG substrate 3 further has an edge (fifth edge) E6 and an edge E8 which face each other and are different from the edges E3 and E4.

According to the functional panel FP2, the COM substrate 4 (i) is provided closer to the display panel LP than the SEG substrate 3 is and (ii) has (a) an edge (third edge) E1 provided, when viewed from above, along and inside the edge E3 when viewed from above and (b) an edge (fourth edge) E2 provided, when viewed from above, along and inside the edge E4. The COM substrate 4 further has an edge (sixth edge) E5 and an edge E7 which face each other and are different from the edges E1 and E2.

The edge E5 is provided along and inside the edge E6 when viewed from above. A terminal TA (not illustrated in (a) through (c) of FIG. 8) is provided in the vicinity of an edge E8. The edge E8 is provided along and outside the edge E7 when viewed from above.

As in the case of the display unit 101 described earlier, it is possible for the display unit 102 including such a functional panel FP2 to prevent a defective external shape caused by the adhesive BO protruding out of the display panel LP.

The edges E1 and E2 of the COM substrate 4 are provided inside the edges E3 and E4, respectively, to such a degree that main wiring lines SM1 and SM2 of the SEG substrate 3 are not exposed. This suppresses the risk of malfunction caused by electrolytic corrosion of the main wiring lines SM1 and SM2 and/or static electricity caused by the main wiring lines SM1 and SM2.

As illustrated in (a) through (c) of FIG. 8, the adhesive BO has pressed-out parts BOa that stick out of the edges E1, E5, and E2 when viewed from above.

The pressed-out parts BOa are in contact with the SEG substrate 3 via steps D1, D2, and D3. This allows the functional panel FP2 and the display panel LP to be firmly fixed to each other, and therefore makes it possible to provide a highly shock resistant display unit 102.

Note that the pressed-out part BOa of the adhesive BO need only stick out, when viewed from above, of at least one of the edges E1, E5, and E2 so as to be in contact with the back surface of the SEG substrate 3.

Alternatively, it is also possible to configure the adhesive BO as illustrated in (a) through (c) of FIG. 9.

(a) of FIG. 9 is a plan view illustrating another configuration of the display unit 102 in accordance with Embodiment 1. (b) of FIG. 9 is a cross-sectional view taken along with the line E-E′ illustrated in (a) of FIG. 9. (c) of FIG. 9 is a cross-sectional view taken along the line F-F′ illustrated in (a) of FIG. 9.

As illustrated in FIG. 9, pressed-out parts BOa of an adhesive BO do not need to be in contact with an SEG substrate 3 via steps D1, D2, and D3.

By employing a configuration in which the pressed-out parts BOa are not in contact with the SEG substrate 3 via the steps D1, D2, and D3, it is possible to combine the counter substrate 1 and the SEG substrate 3 together such that the distance between the counter substrate 1 and the SEG substrate 3 is less affected even in a case where a difference in contraction amount between (i) the lateral end parts of the adhesive BO (including the pressed-out parts BOa) and (ii) the rest of the adhesive BO. This causes the amount of the flexure of the functional panel FP or the display panel LP to be low, and therefore allows prevention of degrading of the display quality of the display unit 102.

### Modification 2

A modification 2 of the display unit 101 will be described below with reference to (a) through (c) of FIG. 10 and (a) through (c) of FIG. 11.

(a) of FIG. 10 is a plan view illustrating a configuration of a display unit 103 in accordance with the modification 2 of Embodiment 1. (b) of FIG. 10 is a cross-sectional view taken along with the line G-G′ illustrated in (a) of FIG. 10. (c) of FIG. 10 is a cross-sectional view taken along the line H-H′ illustrated in (a) of FIG. 10.

The display unit 103 includes a display panel LP2 instead of the display panel LP which is included in the display unit 101.

In other words, the display unit 101 includes a functional panel FP and the display panel LP2 combined together via an adhesive BO.

The display panel LP includes a polarizing plate 52 instead of the polarizing plate 5 included in the display panel LP.

The polarizing plate 52 is provided on a counter substrate 1 so as to face an SEG substrate (second substrate) 3 via the adhesive BO. The polarizing plate 52 has (i) an edge 52E1 provided outside an edge (third edge) E3 when viewed from above and (ii) an edge 52E2 provided outside an edge (fourth edge) E4 when viewed from above.

Hence, the polarizing plate 52 is provided between (i) parts of a back surface of the COM substrate 4 which parts are parts of steps D1 and D2 and (ii) the counter substrate 1. This makes it easy for pressed-out parts BOa of the adhesive BO to be in contact with the COM substrate 4 via the steps D1 and D2. Hence, it is possible to more firmly fix the functional panel FP and the display panel LP2 to each other, and it is therefore possible to provide a highly shock resistant display unit 103.

Alternatively, it is also possible to configure the adhesive BO of the display unit 103 as illustrated in (a) through (c) of FIG. 11.

(a) of FIG. 11 is a plan view illustrating another configuration of the display unit 103 in accordance with Embodiment 1. (b) of FIG. 11 is a cross-sectional view taken along with the line G-G′ illustrated in (a) of FIG. 11. (c) of FIG. 11 is a cross-sectional view taken along the line H-H′ illustrated in (a) of FIG. 11.

As illustrated in FIG. 11, pressed-out parts BOa of an adhesive BO do not need to be in contact with a COM substrate 4 via steps D1, D2, and D3.

In this case, it is possible to combine a counter substrate 1 and a COM substrate 4 together such that a distance between the counter substrate 1 and the COM substrate 4 is less affected by a difference in contraction amount between (i) lateral end parts of the adhesive BO (including the pressed-out parts BOa) and (ii) the rest of the adhesive BO. This causes the amount of the flexure of the functional panel FP2 or the display panel LP to be low, and therefore allows prevention of degrading of the display quality of the display unit 102.

### Modification 3

A modification 3 of the display unit 101 will be described next with reference to (a) through (c) of FIG. 12 and (a) through (c) of FIG. 13.

(a) of FIG. 12 is a plan view illustrating another configuration of a display unit 104 in accordance with the modification 3 of Embodiment 1. (b) of FIG. 12 is a cross-sectional view taken along with the line I-I′ illustrated in (a) of FIG. 12. (c) of FIG. 12 is a cross-sectional view taken along the line J-J′ illustrated in (a) of FIG. 12.

The display unit 104 includes a functional panel FP3 instead of the functional panel FP included in the display unit 101. In other words, the display unit 104 includes the functional panel FP3 and a display panel LP combined together via an adhesive BO.

The functional panel FP3 (i) includes an SEG substrate 33 instead of the SEG substrate 3 included in the functional panel FP and (ii) includes a COM substrate 43 instead of the COM substrate 4 included in the functional panel FP.

The SEG substrate 33 is identical to the SEG substrate 3 except that the SEG substrate 33 is thicker than the SEG substrate 3.

The COM substrate 43 is identical to the COM substrate 4 except that the COM substrate 43 is thinner than the COM substrate 4.

The SEG substrate 33 is thicker than the COM substrate 4. For example, the SEG substrate 33 and the COM substrate 4 have thicknesses of 0.33 mm and 0.2 mm, respectively.

The functional panel FP3 is identical to the functional panel FP in terms of total thickness.

Since the SEG substrate 33, which is closer to the display panel LP than the COM substrate 43 is, is configured to be thus thick, pressed-out parts BOa of the adhesive BO are in contact with edges E3, E7, and E4 over a large area. This makes it unlikely for the pressed-out parts BOa to stick out of the display panel LP, and therefore makes it possible to more reliably prevent the defective external shape.

As illustrated in (a) through (c) of FIG. 12, the pressed-out parts BOa are in contact with the COM substrate 4 via steps D1, D2, and D3. According to the display unit 104, the SEG substrate 33, which is provided closer to the display panel LP than the COM substrate 43 is, is thicker than the COM substrate 43. Hence, the edges E3, E6, and E4 and the pressed-out parts BOa are in contact with each other over a large area. This allows the functional panel FP3 and the display panel LP to be more firmly fixed to each other, and therefore makes it possible to provide a highly shock resistant display unit 104.

Note that the adhesive BO need only have at least one pressed-out part BOa that sticks out, when viewed from above, of the edge E1, E5, or E2 so as to be in contact with a back surface of the COM substrate 43.

Alternatively, it is also possible to configure the adhesive BO of the display unit 104 as illustrated in (a) through (c) of FIG. 13.

(a) of FIG. 13 is a plan view illustrating another configuration of the display unit 104 in accordance with Embodiment 1. (b) of FIG. 13 is a cross-sectional view taken along the line I-I′ illustrated in (a) of FIG. 13. (c) of FIG. 13 is a cross-sectional view taken along the line J-J′ illustrated in (a) of FIG. 13.

As illustrated in FIG. 13, pressed-out parts BOa of an adhesive BO do not need to be in contact with a COM substrate 43 via steps D1, D2, and D3.

By employing a configuration in which the pressed-out parts BOa are not in contact with the COM substrate 43 via the steps D1, D2, and D3, it is possible to combine a counter substrate 1 and the COM substrate 43 together such that a distance between the counter substrate 1 and the COM substrate 4 is less affected by a difference in contraction amount between (i) lateral end parts of the adhesive BO (including the pressed-out parts BOa) and (ii) the rest of the adhesive BO. This causes the amount of the flexure of the functional panel FP3 or the display panel LP to be low, and therefore allows prevention of degrading of the display quality of the display unit 104.

According to the display unit 104, the SEG substrate 33, which is provided closer to the display panel LP than the COM substrate 43 is, is thicker than the COM substrate 43. This makes it unlikely for the pressed-out parts BOa to be in contact with the COM substrate 43 via the steps D1, D2, D3, and therefore makes it possible to provide a display unit 104 whose functional panel FP3 or display panel LP does not easily become flexed.

### Embodiment 2

The following description will discuss Embodiment 2 of the present invention with reference to (a) through (c) of FIG. 14 and (a) through (c) of FIG. 15. For convenience, members whose functions are similar to those of the members illustrated in the drawings described in Embodiment 1 are given the same reference numerals accordingly, and their descriptions are omitted.

(a) of FIG. 14 is a plan view illustrating a configuration of a display unit 105 of Embodiment 2. (b) of FIG. 14 is a cross-sectional view taken along the line K-K′ illustrated in (a) of FIG. 14. (c) of FIG. 14 is a cross-sectional view taken along the line L-L′ illustrated in (a) of FIG. 14.

The display unit 105 is configured so that a display panel LP is provided closer to an observer than a functional panel FP is.

An adhesive BO is provided on a back surface of an active substrate 2 so as to cover a polarizing plate 6 which is provided on the back surface of the active substrate 2. The display unit 105 is configured so that the display panel LP and the functional panel FP are combined together via the adhesive BO.

The functional panel FP includes an SEG substrate (first substrate) 3 and a COM substrate (second substrate) 4 facing each other, and is combined with the display panel LP with via the adhesive BO.

According to the functional panel functional panel FP, the SEG substrate 3 (i) is provided farther from the display panel LP than the COM substrate 4 is and (ii) has an edge (first edge) E3 and an edge (second edge) E4 facing each other. The SEG substrate 3 further has an edge (fifth edge) E6 and an edge E8 which face each other and are different from the edges E3 and E4.

According to the functional panel FP2, the COM substrate 4 (i) is provided closer to the display panel LP than the SEG substrate 3 is and (ii) has (a) an edge (third edge) E1 provided along and inside the edge E3 when viewed from above and (b) an edge (fourth edge) E2 provided along and inside the edge E4 when viewed from above. The COM substrate 4 further has an edge (sixth edge) E5 and an edge E7 which face each other and are different from the edges E1 and E2.

The edge E5 is provided along and outside the edge E6 when viewed from above. A terminal TA (not illustrated in (a) through (c) of FIG. 14) is provided in the vicinity of an edge E8. The edge E8 is provided along and outside the edge E7 when viewed from above.

According to the functional panel FP configured as such, (i) a step D1 is formed by the edges E3 and E1, (ii) a step D2 is formed by the edges E4 and E2, and (iii) a step D3 is formed by the edges E6 and E5.

Therefore, when the functional panel FP and the display panel LP are combined together via the adhesive BO, part of the adhesive BO is pressed out and then flows into the steps D1, D2, and D3. With the functional panel FP, it is therefore possible to prevent the adhesive BO from sticking out of the display panel LP. This makes it possible to prevent defects in an external shape of the display unit 105.

According to the display unit 105, the display panel LP is provided closer to an observer than the functional panel FP is. This allows a panel capable of serving as a touchscreen panel etc. to be provided on a viewing side of the display unit display unit 105. Thus, it is possible to provide a display unit 105 equipped with a touchscreen panel function. That is, it is possible to further provide a panel adding more functions to the display unit 105. This makes it possible to provide a high performance display unit 105.

The polarizing plate 6 has (i) an edge 6E1 provided inside the edge E1 when viewed from above, (ii) an edge 6E2 provided inside the edge E2 when viewed from above, (iii) an edge 6E3 provide inside the edge E5 when viewed from above, and (iv) an edge 6E4 provided inside the edge E7 when viewed from above.

This causes the adhesive BO to be in contact with not only the polarizing plate 5 but also the active substrate 2 which is provide outside the edges 6E1, 6E2, 6E3, and 6E4 when viewed from above. This allows the functional panel FP and the display panel LP to be more firmly fixed to each other.

As illustrated in (a) through (c) of FIG. 14, the adhesive BO has pressed-out parts BOa that stick out of the edges E1, E5, and E2 when viewed from above. The pressed-out parts BOa are located on a back surface of the display panel LP, and do not stick out of the display panel LP. In other words, since the display unit 105 has the steps D1, D2, and D3, it is possible to prevent the pressed-out parts BOa from sticking out of the display panel LP.

The pressed-out parts BOa are in contact with the SEG substrate 3 via the steps D1, D2, and D3. This allows the functional panel FP and the display panel LP to be more firmly fixed to each other, and therefore makes it possible to provide a display unit 101 that is highly shock resistant.

Note that the adhesive BO need only have at least one pressed-out part BOa that sticks out, when viewed from above, of the edge E1, E5, or E2 so as to be contact with a front surface of the SEG substrate 3.

Alternatively, it is possible to configure the adhesive BO as illustrated in FIG. 15.

(a) of FIG. 15 is a plan view illustrating another configuration of the display unit 105 in accordance with Embodiment 2. (b) of FIG. 15 is a cross-sectional view taken along the line K-K′ illustrated in (a) of FIG. 15. (c) of FIG. 15 is a cross-sectional view taken along the line L-L′ illustrated in (a) of FIG. 15.

As illustrated in FIG. 15, pressed-out parts BOa of an adhesive BO do not need to be in contact with an SEG substrate 3 via steps D1, D2, and D3.

By employing a configuration in which the pressed-out parts BOa are not in contact with the SEG substrate 3 via the steps D1, D2, and D3, it is possible to combine an active substrate 2 and the SEG substrate 3 together such that a distance between the active substrate 2 and the SEG substrate 3 is less affected by a difference in contraction amount between (i) lateral end parts of the adhesive BO (including the pressed-out parts BOa) and (ii) the rest of the adhesive BO. This causes the amount of the flexure of the functional panel FP or the display panel LP to be low, and therefore allows prevention of degrading of the display quality of the display unit 105.

Note that the display unit 105 of Embodiment 2 can have modifications similar to the respective modifications 1 through 3 of Embodiment 1.

### Embodiment 3

The following description will discuss Embodiment 3 of the present invention with reference to (a) through (c) of FIG. 16 and (a) through (c) of FIG. 17. For convenience, members whose functions are similar to those of the members illustrated in the drawings described in Embodiments 1 and 2 are given the same reference numerals accordingly, and their descriptions are omitted.

(a) of FIG. 16 is a plan view illustrating a configuration of a display unit 106 in accordance with Embodiment 3. (b) of FIG. 16 is a cross-sectional view taken along the line M-M′ illustrated in (a) of FIG. 16. (c) of FIG. 16 is a cross-sectional view taken along the line N-N′ illustrated in (a) of FIG. 16.

The display unit 106 has (i) an adhesive BO and (ii) a functional panel FP4 and a display panel LP4 combined together via the adhesive BO. According to the display unit 106, steps are formed not only by edges of the functional panel FP4 but also by edges of the display panel LP4.

According to the functional panel FP4, a polarizing plate 7, a COM substrate 4, and an SEG substrate 34 are arranged in this order from an observer's side. The SEG substrate 34 differs from the SEG substrate 3 in that all of edges of the SEG substrate 34 match, when viewed from above, edges of the COM substrate 4 except for an edge around which a terminal section TA is provided. The rest of the configuration of the SEG substrate 34 is similar to the configuration of the SEG substrate 3.

A display panel (bonding panel) LP4 includes an active substrate (first substrate) 12 and a counter substrate (second substrate) 14 facing each other. The display panel LP4 is combined with a functional panel (target panel) FP4 via an adhesive BO.

According to the display panel LP4, a polarizing plate 5, the counter substrate 14, the active substrate 12, and a polarizing plate 6 are arranged in this order from the observer's side.

The adhesive BO covers a front surface of the polarizing plate 5. A back surface of the SEG substrate 34 and the front surface of the polarizing plate 5 face each other via the adhesive BO.

The active substrate 12 is provided farther from the functional panel FP4 than the counter substrate 14 is. The active substrate 12 has an edge (first edge) E9 and an edge (second edge) E10 facing each other. The active substrate 12 further has an edge (fifth edge) E13 and an edge E14 which face each other and are different from the edges E9 and E10.

The counter substrate 14 is provided closer to the functional panel FP4 than the active substrate 12 is. The counter substrate 14 has (i) an edge (third edge) E11 provided along and inside the edge E9 when viewed from above and (ii) an edge (fourth edge) E12 provided along and inside the E10 when viewed from above. The counter substrate 14 further has an edge (sixth edge) E15 and an edge 16 which face each other and are different from the edges E11 and E12.

The counter substrate 14 differs from the counter substrate 1 in that a distance between the edges 11 and 12 is shorter than a distance between the edges E9 and E10. The rest of the configuration of the counter substrate 14 is similar to the configuration of the counter substrate 1.

Hence, according to the display panel LP4, (i) a step D11 is formed by the edges E9 and E11, (ii) a step D12 is formed by the edges El0 and E12, and (iii) a step D13 is formed by the edges E13 and E15.

Therefore, when the display panel LP4 and the functional panel FP4 are combined together via the adhesive BO, part of the adhesive BO is pressed out and then flows into the steps D11, D12, and D13. With the display panel LP4, it is therefore possible to prevent the adhesive BO from sticking out of the functional panel FP4. This makes it possible to prevent defects in an external shape of the display unit 106.

According to the display unit 106, four edges of the polarizing plate 5 are provided, when viewed from above, inside the edges E11, E13, E12, and E16 of the counter substrate 14.

Specifically, the polarizing plate 5 has (i) an edge 5E1 provided inside the edge E11 when viewed from above, (ii) an edge 5E2 provided inside the edge E13 when viewed from above, (iii) an edge 5E3 provided inside the edge E12 when viewed from above, and (iv) an edge 5E4 provided inside the edge E16 when viewed from above.

This causes the adhesive BO to be in contact with not only the polarizing plate 5 but also the counter substrate 14 which is provide outside the edges 5E1, 5E2, 5E3, and 5E4 when viewed from above. This allows the functional panel FP and the display panel LP to be more firmly fixed to each other.

As illustrated in (a) through (c) of FIG. 16, the adhesive BO has pressed-out parts BOa that stick out, when viewed from above, of the edges E11, E12, and E13 of the display unit 106.

The pressed-out parts BOa are in contact with the active substrate 12 via the steps D11, D12, and D13. This allows the functional panel FP4 and the display panel LP4 to be more firmly fixed to each other, and therefore makes it possible to provide a display unit 106 that is highly shock resistant.

Note that the adhesive BO need only have at least one pressed-out part BOa that sticks out, when viewed from above, of the edge E11, E12, or E13 so as to be contact with the front surface of the active substrate 12.

Alternatively, the adhesive BO can also be configured as illustrated in (a) through (c) of FIG. 17.

(a) of FIG. 17 is a plan view illustrating another configuration of a display unit 106 in accordance with Embodiment 3. (b) of FIG. 17 is a cross-sectional view taken along the line M-M′ illustrated in (a) of FIG. 17. (c) of FIG. 17 is a cross-sectional view taken along the line N-N′ illustrated in (a) of FIG. 17.

As illustrated in FIG. 17, pressed-out parts BOa of an adhesive BO do not need to be in contact with an active substrate 12 via steps D11, D12, and D13.

By employing a configuration in which the pressed-out parts BOa are not in contact with the active substrate 12 via the steps D11, D12, and D13, it is possible to combine the active substrate 12 and the SEG substrate 34 together such that the distance between the active substrate 12 and the SEG substrate 34 is less affected by a difference in contraction amount between (i) the lateral end parts of the adhesive BO (including the pressed-out parts BOa) and (ii) the rest of the adhesive BO. This causes the amount of the flexure of a functional panel FP4 or a display panel LP4 to be low, and therefore allows prevention of degrading of the display quality of the display unit 106.

### Modification 1

The following description will discuss, with reference to (a) through (c) of FIG. 18 and (a) through (c) of FIG. 19, a modification 1 in accordance with Embodiment 3 of the present invention. For convenience, members whose functions are similar to those of the members illustrated in the drawings described in Embodiments 1 and 2 are given the same reference numerals accordingly, and their descriptions are omitted.

(a) of FIG. 18 is a plan view illustrating a configuration of a display unit 107 in accordance with the modification 1 of Embodiment 3. (b) of FIG. 18 is a cross-sectional view taken along the line O-O′ illustrated in (a) of FIG. 18. (c) of FIG. 18 is a cross-sectional view taken along the line P-P′ illustrated in (a) of FIG. 18.

The display unit 107 includes (i) an adhesive BO and (ii) a functional panel FP5 and a display unit LP5 combined together via the adhesive BO. The display unit 107 differs from the display unit 106 in that a width of the display panel LP is wider than a width of the functional panel FP5.

According to the functional panel FP5, a polarizing plate 7, a COM substrate 4, and an SEG substrate 35 are arranged in this order from an observer's side. The SEG substrate 35 differs from the SEG substrate 34 in that a width of the SEG substrate 35 is narrower than a width of the COM substrate 4 when viewed from above. The rest of the configuration of the SEG substrate 35 is similar to the configuration of the SEG substrate 34.

The SEG substrate (bonding panel, target panel) 35 includes the COM substrate (first substrate) 4 and the SEG substrate (second substrate) 35 which face each other. The SEG substrate 35 is combined with the display panel (target panel, bonding panel) LP5 via the adhesive BO.

According to the display panel LP5, a polarizing plate 5, a counter substrate 15, an active substrate 25, and a polarizing plate 6 are arranged in this order from the observer's side. The counter substrate 15 and the active substrate 25 differ from the counter substrate 14 and the active substrate 2, respectively, in that widths of the counter substrate 15 and the active substrate 25 are each wider than a width of the functional panel FP5. The rest of the configurations of the counter substrate 15 and the active substrate 25 is similar to the configurations of the counter substrate 14 and the active substrate 2.

The display panel (bonding panel) LP5 includes the counter substrate (first substrate) 15 and the active substrate (second substrate) 25 which face each other. The display panel LP5 is combined with the functional panel (target panel, bonding panel) FP5 via the adhesive BO.

The adhesive BO covers a front surface of the polarizing plate 5. The front surface of the polarizing plate 5 and a back surface of the SEG substrate 35 face each other via the adhesive BO.

The active substrate 25 is provided farther from the functional panel FP5 than the counter substrate 15 is. The active substrate 25 has an edge (first edge) E13 and an edge (second edge) E14 which face each other. The active substrate 25 further has edges which face each other and are different from the edges E13 and E14.

The counter substrate 15 is provided closer to the functional panel FP5 than the active substrate 25 is. The counter substrate 15 has (i) an edge (third edge) E15 provided along and inside the edge E13 when viewed from above and (ii) an edge (fourth edge) E16 provided along and inside the E14 when viewed from above. The counter substrate 15 further has edges which face each other and are different from the edges E15 and E16.

The counter substrate 15 differs from the counter substrate 14 in that a distance between the other edges (other than the edges E15 and E16) is longer than a distance between the edges E1 and E2 of the functional panel FP5. The rest of the configuration of the counter substrate 15 is similar to the configuration of the counter substrate 14.

The active substrate 25 differs from the active substrate 2 in that a distance between the edges (other than the edges E13 and E14) is longer than the distance between the edges E1 and E2 of the functional panel FP5. The rest of the configuration of the active substrate 25 is similar to the configuration of the active substrate 2.

Hence, according to the display panel LP5, (i) a step D13 is formed by the edges E13 and E15 and (ii) a step D14 is formed by the edges E14 and E16.

Therefore, when the display panel LP5 and the functional panel FP5 are combined together via the adhesive BO, part of the adhesive BO is pressed out and then flows into the steps D13 and D14. With the display panel LP5, it is therefore possible to prevent the adhesive BO from sticking out of the functional panel FP5. This makes it possible to prevent defects in an external shape of the display unit 106.

The COM substrate 4 is provided farther from the display panel LP than the SEG substrate 35 is. The COM substrate 4 has an edge (first edge) E1 and an edge (second edge) E2 which face each other. The COM substrate 4 further has edges which face each other and are different from the edges E1 and E2.

The SEG substrate 35 is provided closer to the display panel LP5 than the COM substrate 4 is. The SEG substrate 35 has (i) an edge (third edge) E3 provided along and inside the edge E1 when viewed from above and (ii) an edge (fourth edge) E4 provided along and inside the edge E2 when viewed from above. The SEG substrate 35 further has edges which face each other and are different from the edges E3 and E4.

The SEG substrate 35 differs from the SEG substrate 34 in that a distance between the edges E3 and E4 is shorter than a distance between the edges E1 and E2. The rest of the configuration of the SEG substrate 35 is similar to the configuration of the SEG substrate 34.

According to the functional panel FP5, (i) a step D1 is formed by the edges E1 and E3 and (ii) a step D2 is formed by the edges E2 and E4.

Therefore, when the display panel LP5 and the functional panel FP5 are combined together via the adhesive BO, part of the adhesive BO is pressed out and then flows into the steps D1 and D2. With the functional panel FP, it is therefore possible to prevent the adhesive BO from sticking out of the display panel LP5. This makes it possible to prevent defects in the external shape of the display unit 106.

Since the display unit 106 thus has four steps, D1, D2, D13, and D14, the occurrence of a defective external shape can be highly effectively suppressed.

As illustrated in (a) through (c) of FIG. 18, the adhesive BO has pressed-out parts BOa that stick out, when viewed from above, of the edges E3, E4, E15, and E16 of the display unit 107.

The pressed-out parts BOa are in contact with not only the SEG substrate 3 and the active substrate 15 via the steps D1 and D2 but also the COM substrate 4 and the active substrate 25 via the steps D13 and D14. This allows the functional panel FP5 and the display panel LP5 to be more firmly fixed to each other, and therefore makes it possible to provide a display unit 107 that is highly shock resistant.

Note that the adhesive BO need only have at least one pressed-out part BOa that sticks out, when viewed from above, of the edge E3, E4, E15, or E16 so as to be contact with a front surface of the active substrate 25 or with a back surface of the COM substrate 4.

Alternatively, the adhesive BO can also be configured as illustrated in (a) through (c) of FIG. 19.

(a) of FIG. 19 is a plan view illustrating another configuration of the display unit 107 in accordance with Embodiment 3. (b) of FIG. 19 is a cross-sectional view taken along the line O-O′ illustrated in (a) of FIG. 19. (c) of FIG. 19 is a cross-sectional view taken along the line P-P′ illustrated in (a) of FIG. 19.

As illustrated in FIG. 19, a display unit 107 can be configured so that pressed-out parts BOa of an adhesive BO are (i) not in contact with a COM substrate 4 via steps D1 and D2 and (ii) not in contact with an active substrate 25 via steps D13 and D14.

By employing a configuration in which the pressed-out parts BOa are not in contact with the COM substrate 4 via the steps D1 and D2 and not in contact with the active substrate 25 via the steps D3 and D14, it is possible to combine the active substrate 25 and the SEG substrate 35 together and to combine the counter substrate 15 and the COM substrate 4 together such that a distance between the active substrate 25 and the SEG substrate 35 and a distance between the counter substrate 15 and the COM substrate 4 are less affected by a difference in contraction amount between (i) the lateral end parts of the adhesive BO (including the pressed-out parts BOa) and (ii) the rest of the adhesive BO. This causes the amount of the flexure of a functional panel FP5 or a display panel LP5 to be low, and therefore allows prevention of degrading of the display quality of the display unit 107.

It is thus possible to provide the display unit 107 regardless of which of the functional panel FP5 and the display panel LP5 has a larger surface area. Since whichever (of the functional panel FP5 and the display panel LP5) has a larger surface area is not subjected to a cutting-off process for forming a step(s) with which an adhesive BO is to be in contact, it is possible to prevent an increase in a risk of a defective external shape (cracks).

The present invention is not limited to the description of the embodiments, but can be altered in many ways by a person skilled in the art within the scope of the claims. An embodiment derived from a proper combination of technical means disclosed in different embodiments is also encompassed in the technical scope of the present invention.

In order to attain the object, a bonding panel of the present invention, which is to be combined with a target panel via an adhesive, includes a first substrate and a second substrate provided so as to face each other, the first substrate being provided farther from the target panel than the second substrate is, the first substrate having a first edge and a second edge which face each other, and the second substrate having, when viewed from above, (i) a third edge provided along and inside the first edge and (ii) a fourth edge provided along and inside the second edge.

According to the configuration, a step is formed by the first and second edges, and another step is formed by the second and fourth edges. This allows, when the bonding panel is combined with the target panel via the adhesive, pressed-out parts of the adhesive to flow into the steps formed by the first and second edges and into the steps formed by the third and fourth edges. Therefore, a defective external shape can be more effectively prevented.

It is preferable to configure the bonding panel such that the target panel is a display panel, and the bonding panel adds a function to the display panel. Alternatively, it is also preferable to configure the bonding panel such that the bonding panel is a display panel.

It is preferable to configure the bonding panel such that the second substrate is thicker than the first substrate.

With the configuration, it is possible to cause the adhesive to be in contact with the third and fourth edges of the second substrate. This allows the bonding panel and the target panel to be more firmly combined together, and therefore allows for increased shock resistance.

It is preferable to configure the bonding panel such that: the first substrate has a fifth edge; and the second substrate has, when viewed from above, a sixth edge provided along and inside the fifth edge.

According to the configuration, another step is formed by the fifth and sixth edges. This makes it possible to more reliably prevent the adhesive from being pressed out, and therefore makes it possible to prevent the defective external shape.

It is preferable to configure the bonding panel such that: the first substrate has a seventh edge; the second substrate has, when viewed from above, an eighth edge provided along the seventh edge; and a terminal section is provided in the vicinity of the seventh edge or of the eighth edge. This makes it possible to supply, via the terminal section, a signal from outside into the first substrate or the second substrate.

A display unit of the present invention preferably includes: a target panel; and a bonding panel as set forth in claim 1 which is combined with the target panel via an adhesive, either one of the target panel or the bonding panel being a display panel.

According to the configuration, the adhesive is prevented from being pressed out. This makes it possible to provide a display panel that is prevented from having a defective external shape.

It is preferable to configure the display unit such that part of the adhesive sticks out, when viewed from above, of either one of the third edge or the fourth edge. With the configuration, it is possible to provide a display unit in which the target panel and the bonding panel are combined together via an adhesive.

It is preferable to configure the display unit such that the part of the adhesive is in contact with the first substrate.

Alternatively, it is also possible to configure the display unit such that the part of the adhesive is not in contact with the first substrate. In such a case, it is possible to prevent the flexure of the target panel or the bonding panel.

It is preferable to configure the display unit such that the target panel has, when viewed from above, (i) an edge provided along and outside the first edge and (ii) an edge provided along and outside the second edge.

According to the configuration, the adhesive is made unlikely to flow out of the target panel. This makes it possible to further prevent the occurrence of the defective external shape.

It is preferable to configure the display unit such that: the target panel is a display panel; and the bonding panel is a functional panel for adding a function to the display panel. With the configuration, it is possible to obtain a display unit in which a display panel is equipped with a certain function.

The display unit is configured such that: the bonding panel is a display panel; and the target panel is a functional panel for adding a function to the display panel.

It is preferable to configure the display such that: the target panel includes a polarizing plate that faces the second substrate via the adhesive; and the polarizing plate has, when viewed from above, (i) an edge provided along and inside the third edge and (ii) an edge provided along and inside the fourth edge.

With the configuration, it is possible to cause the adhesive to be in contact with not only the polarizing plate but also the target panel. This allows the target panel and the bonding panel to be more firmly fixed to each other.

It is preferable to configure the display such that: the target panel includes a polarizing plate that faces the second substrate via the adhesive; and the polarizing plate has, when viewed from above, (i) an edge provided along and outside the third edge and (ii) an edge provided along and outside the fourth edge.

According to the configuration, the polarizing plate is provided between (i) the target panel and (ii) parts of a back surface of the first substrate which parts are parts of (a) the step formed by the first and third edges and (b) the step formed by the second and fourth edges. This makes it easy for pressed-out parts of the adhesive to be in contact with the first substrate via (I) the step formed by the first and third edges and (II) the step formed by the second and fourth edges.

Hence, it is possible to more reliably and more firmly fix the target panel and the bonding panel to each other. This makes it possible to provide a display unit that is highly shock resistant.

It is preferable to configure the display unit such that the bonding panel is provided closer to an observer's side than the target panel is. With the configuration, it is possible to provide the display unit.

It is preferable to configure the display unit such that the target panel is provided closer to an observer's side than the bonding panel is. With the configuration, it is possible to further provide, on the observer's side of the target panel, a panel for adding a function to the target panel. This makes it possible to provide a high performance display unit.

It is preferable to configure the display unit such that: the first substrate includes a first comb-like electrode and a second comb-like electrode that mesh with each other; and the second substrate includes a third comb-like electrode and a fourth comb-like electrode that mesh with each other. With the configuration, it is possible to cause the bonding panel to function as a parallax barrier-specific panel by generating voltage (i) between the first and second comb-like electrodes or (ii) between the third and fourth comb-like electrodes.

It is preferable to configure the display unit such that: teeth parts of the respective first and second comb-like electrodes extend in a first direction; teeth parts of the respective third and fourth comb-like electrodes extend in a second direction; and the first direction and the second direction intersect with each other. With the configuration, it is possible to form a parallax barrier that is arranged in (i) a direction in which the first and second comb-like electrodes extend or (ii) a direction in which the third and fourth comb-like electrodes extend.

It is preferable to configure the display unit such that neither a main part of the first comb-like electrode nor a main part of the second comb-like electrode overlaps a main part of the third comb-like electrode and a main part of the fourth comb-like electrode. This allows for a reduction in a load between (i) the main parts of the first and second comb-like electrodes and (ii) the main parts of the third and fourth comb-like electrodes.

It is preferable to configure the display unit such that neither the first comb-like electrode nor the second comb-like electrode protrudes out of the third edge and the fourth edge when viewed from above. According to the configuration, the first and second comb-like electrodes are each prevented from being exposed. This makes it possible to prevent the occurrence of malfunction caused by electrolytic corrosion and/or static electricity.

It is preferable to configure the display unit such that the main part of the first comb-like electrode has a part whose external edge matches part of the third edge or of the fourth edge. With the configuration, it is possible to prevent the main part of the first comb-like electrode from being exposed, and therefore to prevent the occurrence of malfunction caused by electrolytic corrosion and/or static electricity.

It is preferable to configure the display unit such that: the first substrate includes a transistor and a pixel electrode to be connected to the transistor; and the second substrate includes a common electrode that faces the pixel electrode.

A display device of the present invention preferably includes the display unit. This makes it possible to obtain a display device that is prevented from having a defective external shape.

It is preferable to configure the display device such that the target panel is a liquid crystal panel. This makes it possible to configure a display device.

### INDUSTRIAL APPLICABILITY

The present invention is applicable to a bonding panel, a display unit, and a display device, each of which provides a desirable function by combining a plurality of panels via an adhesive.

### REFERENCE SIGNS LIST

| | |
|---|---|
| 1 | Counter substrate |
| 2 | Active substrate |
| 3 | SEG substrate |
| 4 | COM substrate |
| 5, 6, 7 | Polarizing plate |
| 5E1, 5E2, 5E3, 5E4 | Edge |
| 6E1, 6E2, 6E3, 6E4 | Edge |
| 10, 101, 102, 103, 104, | Display Unit |
| 105, 106, 107 | Display Unit |
| 12 | Active substrate |
| 100 | Display device |
| BO | Adhesive |
| BOa | Pressed-out part |
| C1, C2 | COM Electrodes |
| CM1, CM2, SM1, SM2 | Main wiring line |
| D1, D2, D3 | Step |
| E1, E2, E3, E5, E6, E7, E8 | Edge |
| FP | Functional panel |
| LP | Display panel |
| S1 | SEG electrode |
| S1, S2 | SEG electrode |
| SM1, SM2 | Main wiring line |

1. A bonding panel to be combined with a target panel via an adhesive, comprising:
a first substrate and a second substrate provided so as to face each other,
the first substrate being provided farther from the target panel than the second substrate is,
the first substrate having a first edge and a second edge which face each other, and
the second substrate having, when viewed from above, (i) a third edge provided along and inside the first edge and (ii) a fourth edge provided along and inside the second edge.

2. The bonding panel as set forth in claim 1, wherein the target panel is a display panel, and the bonding panel adds a function to the display panel.

3. The bonding panel as set forth in claim 1, wherein the bonding panel is a display panel.

4. The bonding panel as set forth in claim 1, wherein the second substrate is thicker than the first substrate.

5. The bonding panel as set forth in claim 1, wherein:
the first substrate has a fifth edge; and
the second substrate has, when viewed from above, a sixth edge provided along and inside the fifth edge.

6. The bonding panel as set forth in claim 1, wherein:
the first substrate has a seventh edge;
the second substrate has, when viewed from above, an eighth edge provided along the seventh edge; and
a terminal section is provided in the vicinity of the seventh edge or of the eighth edge.

7. A display unit comprising:
a target panel; and
a bonding panel as set forth in claim 1 which is combined with the target panel via an adhesive,
either the target panel or the bonding panel being a display panel.

8. The display unit as set forth in claim 7, wherein part of the adhesive sticks out, when viewed from above, of either the third edge or the fourth edge.

9. The display unit as set forth in claim 8, wherein the part of the adhesive is in contact with the first substrate.

10. The display unit as set forth in claim 8, wherein the part of the adhesive is not in contact with the first substrate.

11. The display unit as set forth in claim 7, wherein the target panel has, when viewed from above, (i) an edge provided along and outside the first edge and (ii) an edge provided along and outside the second edge.

12. The display unit as set forth in claim 7, wherein:
the target panel is a display panel; and
the bonding panel is a functional panel for adding a function to the display panel.

13. The display unit as set forth in claim 7, wherein:
the bonding panel is a display panel; and
the target panel is a functional panel for adding a function to the display panel.

14. The display unit as set forth in claim 12, wherein:
the target panel includes a polarizing plate that faces the second substrate via the adhesive; and
the polarizing plate has, when viewed from above, (i) an edge provided along and inside the third edge and (ii) an edge provided along and inside the fourth edge.

15. The display unit as set forth in claim 12, wherein:
the target panel includes a polarizing plate that faces the second substrate via the adhesive; and
the polarizing plate has, when viewed from above, (i) an edge provided along and outside the third edge and (ii) an edge provided along and outside the fourth edge.

16. The display unit as set forth in claim 12, wherein the bonding panel is provided closer to an observer's side than the target panel is.

17. The display unit as set forth in claim 12, wherein the target panel is provided closer to an observer's side than the bonding panel is.

18. The display unit as set forth in claim 12, wherein:
the first substrate includes a first comb-like electrode and a second comb-like electrode that mesh with each other; and
the second substrate includes a third comb-like electrode and a fourth comb-like electrode that mesh with each other.

19. The display unit as set forth in claim 18, wherein:
teeth parts of the respective first and second comb-like electrodes extend in a first direction;
teeth parts of the respective third and fourth comb-like electrodes extend in a second direction; and
the first direction and the second direction intersect with each other.

20. The display unit as set forth in claim 18, wherein neither a main part of the first comb-like electrode nor a main part of the second comb-like electrode overlaps a main part of the third comb-like electrode and a main part of the fourth comb-like electrode.

21. The display unit as set forth in claim 18, wherein neither the first comb-like electrode nor the second comb-like electrode protrudes out of the third edge and the fourth edge when viewed from above.

22. The display unit as set forth in claim 21, wherein the main part of the first comb-like electrode has a part whose external edge matches part of the third edge or of the fourth edge.

23. The display unit as set forth in claim 13, wherein:
the first substrate includes
a transistor and
a pixel electrode to be connected to the transistor; and
the second substrate includes
a common electrode that faces the pixel electrode.

24. A display device comprising:
a display unit as set forth in claim 7.

25. The display device as set forth in claim 24, wherein the target panel and the bonding panel are each a liquid crystal panel.
